(19) United States
(12) Patent Application Publication
(10) Pub. No.: US 2003/0177379 A1
(43) Pub. Date: Sep. 18, 2003

(54) Storing device allowing arbitrary setting of storage region of classified data

(75) Inventors: Yoshihiro Hori, Gifu-shi (JP); Toshiaki Hioki, Ogaki-shi (JP)

Correspondence Address: McDermott, Will & Emery, 600 13th Street, N.W., Washington, DC, 20005-3096, US

(73) Assignee: Sanyo Electric Co., Ltd.

(21) Appl. No.: 10/385,436

(22) Filed: Mar. 12, 2003

(30) Foreign Application Priority Data
Mar. 14, 2002 (JP) 2002-070330 (P)

(51) Int. Cl. H04L 9/32

(52) U.S. Cl. 713/193

(57) ABSTRACT

A hard disk unit includes a data storage region. The data storage region includes a user region and a non-user region. The user region is formed of a normal data storage region storing non-classified data and a protection data storage region storing classified data. The non-user region is formed of an administration data storage region. The administration data storage region stores a certificate revocation list CRL and an administration table of the classified data. Logical addresses of 0-maxLBA are assigned to the user region, and logical addresses of (sLBA+1)-maxLBA among them are assigned to a protection data storage region. By changing sMAX in accordance with an external instruction, the region of the protection data storage region is changed.

### BACKGROUND OF THE INVENTION

1. Field of the Invention

The present invention relates to a data storing device storing a license used for decrypting and reproducing encrypted data, which is obtained in a data distribution system allowing copyright protection of copied information, and particularly, to a data storing device allowing copyright protection of information, which is copied in a storing device allowing multi-access.

2. Description of the Background Art

Owing to advance of digital communication networks such as the Internet in recent years, users of personal terminals such as cellular phones can easily access network information.

Such digital communication networks transmit information taking the form of digital data. Therefore, each user can copy music data, movie data or the like, which is transmitted over the digital communication network, without causing substantially deterioration of a sound or image quality due to the copying.

Accordingly, if the content data such as music data or image data, which is protected by a right of copyright owner, is transmitted over the digital communication network without appropriate measures for copyright protection, the right of the copyright owner may be significantly infringed.

Conversely, if top priority is given to the copyright protection by disabling or inhibiting sending of content data over the rapidly increasing digital communication network, this basically causes disadvantages to the copyright owner, who can collect a predetermined copyright royalty for distribution of the content data.

However, the public distribution itself of content data such as music data or image data over the digital communication network is restricted by the pubic transmission right of the copyright owner. In connection with the public distribution, therefore, sufficient measures must be taken for the copyright protection.

For the above, it is necessary to prevent unauthorized further copy of the content data such as music data or image data, which was sent to the public over the digital communication network, and was once received.

Such a data distribution system has been proposed that a distribution server holding encrypted content data, which is produced by encrypting the content data, distributes the encrypted content data to memory cards attached to terminal devices such as cellular phones. In this data distribution system, a public encryption key of the memory card, which has been authenticated by a certification authority, and its certificate are sent to the distribution server when the distribution of encrypted content data is requested. After the distribution server determines the reception of the authenticated certificate, the encrypted content data and a license for decrypting the encrypted content data are sent to the memory card. The license includes a decryption key (which will be referred to as a “content key” hereinafter”) for decrypting the encrypted content data, a license ID for identifying the license, control information for restricting use of the license key and others. In sending the license from the distribution server to a hard disk unit, the distribution server and the memory card produce session keys, respectively, and exchange them with each other to form an cipher communication path.

Finally, the distribution server sends the license to the memory card via the cipher communication path thus formed. In this operation, the memory card stores the received encrypted content data and license in its internal memory.

In reproducing the encrypted content data stored in the memory card, the memory card is attached to the terminal device provided with a dedicated circuit, which reads the encrypted content data and the content key from the memory card, and decrypts the encrypted content data to reproduce and output the data externally. In reading out the content key, an cipher communication path is formed between the memory card and the dedicated circuit, and the content key is sent from the memory card to the dedicated circuit via the cipher communication path.

The memory card has a function of performing shift or copy to or from another memory card. According to this function, the cipher communication path is formed by the functions of both the memory cards on the sender and receiver sides similarly to the sending of the license from the distribution server, and the license is sent from the memory card on the sender side to the memory card on the receiver side.

As described above, the user of the cellular phone can receive the encrypted content data and the license from the distribution server over the cellular phone network, and can store them in the memory card. Thereby, the user can reproduce the encrypted content data stored in the memory card, and can move it to another memory card. Also, the right of the copyright owner can be protected.

Owing to development of digital broadcast networks and increase in area of digital communication paths in recent years, it is becoming possible to send a larger amount of data. As a result of these changes in data sending environment, an infrastructure is changing to allow distribution of a large amount of movie data instead of a relatively small amount of content data such as music data.

As a data storing device for storing the movie content, the memory card cannot be suitably used because the memory card has a small data storage capacity, and a storage price per bit is high when handling data of a slow access speed so that the memory card is not suitable for image data.

It is assumed that the data storing device storing a large amount of content such as movie and the data storing device storing a relatively small amount of content such as a music content have license storage capacities, which are uniform regardless of the stored contents, as a result of the increase in capacities of the data storing devices. This results in such problems that the encrypted content data of the image content cannot be stored although a free space is left in the region storing the licenses, and that the licenses of the music content cannot be stored although a free space is left in the region storing the encrypted content data. These problems become more remarkable as the storage capacity of the data storing device increases.

### SUMMARY OF THE INVENTION

Accordingly, an object of the invention is to provide a data storing device, in which a region for recording classified data can be arbitrarily set.

According to the invention, a data storing device inputting/outputting classified data and non-classified data, and storing the classified data and the non-classified data, includes an interface performing external input and output of data; a data storing unit storing data; an cipher communication unit forming an cipher path to a supplier or a receiver of the classified data in input/output of the classified data via the interface, and performing the input/output of the classified data via the cipher path; and a control unit. The data storage unit includes a user region storing the classified data and the non-classified data. The user region is divided into a first storage region storing classified data, and a second storage region defined by subtracting the first storage region from the user region and storing the non-classified data. The control unit writes or reads the data input or output via the interface and the cipher communication unit, as the classified data, into or from the first storage region, and writes or reads the data input or output via only the interface, as the non-classified data, into or from the second storage region.

Preferably, the user region can be designated by continuous addresses. The data storing device further includes a function information unit providing, to the interface, function information required for using the data storing device, and including at least information for specifying an address range designating the first and/or second storage region(s) and information required for performing cipher communication via the cipher communication unit.

Preferably, division into the first and second storage regions is changed by inputting via the interface a changed value specifying a range of an address specifying the first and/or second storage region(s).

Preferably, the data storing device further includes an encryption processing unit encrypting the classified data with a private key administered within the data storing device, and a decryption processing unit decrypting the encrypted classified data with the private key. In writing the classified data, the encryption processing unit encrypts the classified data provided via the cipher communication unit with the private key, and the control unit receives via the interface an address in the first storage region for writing the classified data provided via the cipher communication unit, and stores the encrypted classified data encrypted by the encryption processing unit at the region designated by the received address in the first storage region. In reading the encrypted classified data, the control unit receives the address in the first storage region for reading out the classified data via the interface, reads the encrypted classified data from the region designated by the received address in the first storage region and provides the encrypted classified data to the decryption processing unit. The decryption processing unit decrypts the encrypted classified data provided from the control means with the private key.

Preferably, the cipher communication unit is formed of an independent semiconductor element.

Preferably, the changed value is a boundary address designating a boundary between the first and second storage regions.

Preferably, the cipher communication unit includes an authenticating unit receiving a certificate provided from other device, and performing authentication processing of authenticating the received certificate, and a communication control unit. In reading the classified data, the communication control unit provides the certificate received via the interface to the authenticating unit, forms an cipher path to an output destination of the certificate when the authenticating unit authenticates the certificate, and externally outputs an error message via the interface when the certificate is not authenticated.

Preferably, the data storing unit further includes a non-user region for recording a certificate revocation list including information specifying a certificate inhibiting output of the classified data, and the communication control unit reads the certificate revocation list from the non-user region, and further determines whether the certificate provided from other device is specified in the certificate revocation list or not. In reading the classified data, when the authenticating unit authenticates the received certificate, the communication control unit reads the certificate revocation list from the non-user region, determines whether the received certificate is specified in the certificate revocation list or not, forms the cipher path to the output destination of the certificate in response to determination that the received certificate is not specified in the certificate revocation list, and externally outputs the error message via the interface in response to determination that the received certificate is specified in the certificate revocation list.

Preferably, in writing the classified data, when the communication control unit receives a new certificate revocation list together with the classified data, the communication control unit overwrites the certificate revocation list stored in the non-user region with the received certificate revocation list.

According to the invention, a data storing device inputting/outputting classified data and non-classified data, and storing the classified data and the non-classified data, includes an interface performing external input/output of the data; a disk-like magnetic record medium storing the data; a write/read processing unit performing writing and reading of the data into and from the disk-like magnetic record medium; an cipher communication unit forming an cipher path to a supplier or a receiver of the classified data for input/output of the classified data via the interface, and performing the input/output of the classified data via the formed cipher path; and a control unit. The disk-like magnetic record medium includes a user region keeping a constant storage capacity for storing the classified data and the non-classified data, the user region is divided into a first storage region storing the classified data, and a second storage region defined by subtracting the first storage region from the user region for storing the non-classified data. The control unit controls the write/read processing unit to write or read, as the classified data, the data provided via the interface and the cipher communication unit, and controls the write/read processing unit to write or read, as the non-classified data, the data input or output via only the interface into or from the second storage region.

Preferably, the data storing device further includes an encryption processing unit encrypting the classified data with a private key administered within the data storing device, and a decryption processing unit decrypting the encrypted classified data with the private key. In writing the classified data, the encryption processing unit encrypts the classified data provided via the cipher communication unit with the private key, and the control unit controls the write/read processing unit to receive via the interface an address in the first storage region for writing the classified data provided via the cipher communication unit, and to store the encrypted classified data encrypted by the encryption processing unit at the region designated by the received address in the first storage region. In reading the encrypted classified data, the control unit controls the write/read processing unit to receive the address in the first storage region for reading out the classified data via the interface, and to read the encrypted classified data from the region designated by the received address in the first storage region, and provides the encrypted classified data to the decryption processing unit. The decryption processing unit decrypts the encrypted classified data provided from the control unit with the private key.

Preferably, the cipher communication unit is formed of an independent semiconductor element.

Preferably, the user region can be designated by continuous addresses. Division into the first and second storage regions is changed by inputting via the interface a changed value specifying a range of an address specifying the first and/or second storage region(s).

According to the invention, therefore, the region for storing the classified data can be arbitrarily set.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a structure of a system for storing a content in a hard disk unit.

FIG. 2 schematically shows a structure for reproduction processing of a content stored in the hard disk unit.

FIG. 3 schematically shows a structure for shift/copy processing of a content stored in the hard disk unit between hard disk units.

FIG. 4 illustrates characteristics of data, information and others handled in the system shown in FIG. 1.

FIG. 5 illustrates characteristics of the data, keys and others used for data protection in the system shown in FIG. 1.

FIG. 6 is a schematic functional block diagram illustrating a structure of a download server shown in FIG. 1.

FIG. 7 is a functional block diagram showing a structure of a terminal device shown in FIG. 1.

FIG. 8 is a functional block diagram showing a structure of a hard disk unit shown in FIG. 1.

FIG. 9 illustrates a structure of a storage region in the hard disk unit.

FIG. 10 illustrates a manner of storing a content in the hard disk unit.

FIG. 11 is a flow chart illustrating processing performed on the hard disk unit by the terminal device shown in FIG. 1.

FIG. 12 is a flow chart specifically illustrating initializing processing in the flow chart illustrated in FIG. 11.

FIGS. 13 and 14 are first and second flow charts illustrating an operation of distributing a license in the system shown in FIG. 1, respectively.

FIGS. 15, 16 and 17 are first, second and third flow charts illustrating an operation of moving or duplicating the license in the structure shown in FIG. 3, respectively.

FIGS. 18 and 19 are first and second flow charts illustrating a detail operation for usage permission processing of license in the structure shown in FIG. 2, respectively.

FIG. 20 is a flow chart illustrating a detail operation for normal data write processing illustrated in FIG. 11.

FIG. 21 is a flow chart illustrating a detail operation for normal data read processing illustrated in FIG. 11.

FIG. 22 is a block diagram showing another structure of a hard disk unit shown in FIG. 1.

### DESCRIPTION OF THE PREFERRED EMBODIMENTS

Embodiments of the invention will now be described with reference to the drawings. In the figures, the same or corresponding portions bear the same reference numbers, and description thereof is not repeated.

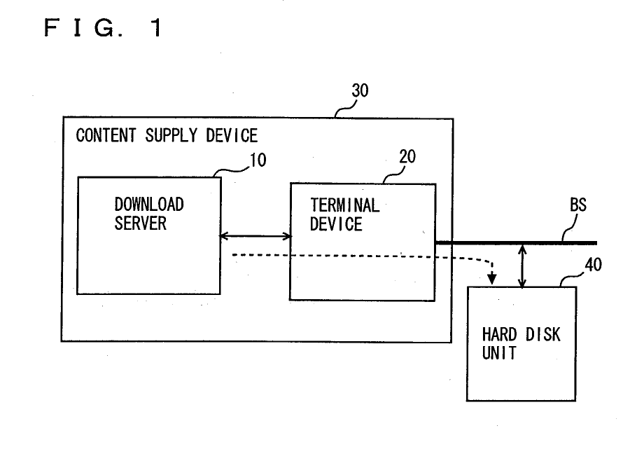

FIG. 1 schematically shows a structure for storing an encrypted content data and a license to be used for decrypting the encrypted content data in a hard disk unit provided with a data protecting function according to the invention.

A content supply device 30 is provided for supplying the encrypted content data and the license to be recorded in a hard disk unit 40, and is connected to hard disk unit 40 via a data bus BS for transmitting the data via data bus BS.

The following description will be given by way of example on a distribution system, in which movie data is downloaded over the Internet and is recorded in hard disk unit 40. However, as will be apparent from the following description, the invention is not restricted to it, and can be applied to various structures and systems such as a data recorder, in which encrypted content data and a license are produced by taking in raw data and are recorded in hard disk unit 40, a broadcast receiving system, in which the encrypted content data or license received over a broadcast network is recorded in a hard disk unit 40, and a composite distribution system, in which the license is obtained over a digital communication network.

Thus, content supply device 30 may obtain the encrypted content data and the license via any path, and has a function of transmitting the data to and from hard disk unit 40, and sending the encrypted content data and the license to hard disk unit 40.

The data to be sent is not restricted to the image data, and may be another kind of copyrighted content data such as music data, image data, reading or recital data, text data, computer program or game software.

Referring to FIG. 1, in data communication system, content supply device 30 is formed of a download server 10 and a terminal device 20. Hard disk unit 40 is an independent unit having a connector allowing connection/disconnection. Data bus BS can be connected to hard disk unit 40 via a mechanism for attaching hard disk unit 40. Terminal device 20 is connected to download server 10, which distributes the content over the digital communication network.

Download server 10 receives a distribution request, which is made by a user of terminal device 20 provided with hard disk unit 40, from terminal device 20. Download server 10 administering the image data determines whether hard disk unit 40 attached to terminal device 20, which sent the distribution request, has a valid certificate or not, and thus whether it is a regular storing device having a protection function or not. If hard disk unit 40 is a regular hard disk unit, download server 10 sends encrypted data, which is produced by encrypting the image data (to be referred to as “content data” hereinafter) according to a predetermined cryptosystem for protecting the copyright in hard disk unit 40, and a content key Kc for decrypting the encrypted content data to terminal device 20.

Terminal device 20 performs mediation processing between download server 10 and hard disk unit 40 for recording the encrypted content data and the license in hard disk unit 40.

For this sending of the license, a secure connection (i.e., cipher communication path) is formed between download server 10 and hard disk unit 40, and the license is sent via the secure connection. Thus, the license is sent in a form encrypted to allow decryption only in hard disk unit 40, and is recorded after being decrypted in hard disk unit 40. Formation of the secure connection will be described later in greater detail. This processing of recording the license in hard disk unit 40 is referred to as “write” hereinafter.

If terminal device 20 has a reproducing function, it can read the encrypted content data and the license recorded in hard disk unit 40, and can reproduce the encrypted content data.

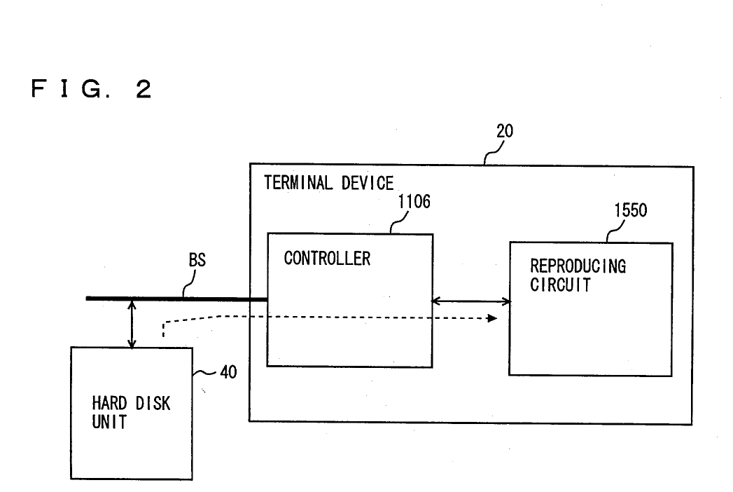

FIG. 2 schematically shows a structure, in which terminal device 20 having the reproduction function reads the encrypted content data and the license stored in hard disk unit 40, and reproduces it.

Referring to FIG. 2, terminal device 20 is formed of a controller 1106, which internally controls terminal device 20 itself, and controls sending and receiving of data to and from hard disk unit 40 via data bus BS, and a reproducing circuit 1550 having a data protection function, which reproduces the content based on the encrypted content data and the license.

In reproducing the content, the secure connection is also formed between hard disk unit 40 and reproducing circuit 1550, and the license to be used for the reproduction is sent from hard disk unit 40 to reproducing circuit 1550 via the secure connection thus formed. In this operation, hard disk unit 40 authenticates a certificate of reproducing circuit 1550, and thereby determines the validity of reproducing circuit 1550. Processing of sending the license including the content key to reproducing circuit 1550, and preparing for reproduction of the encrypted content data will be referred to as “usage permission” hereinafter. Detail description will be given later.

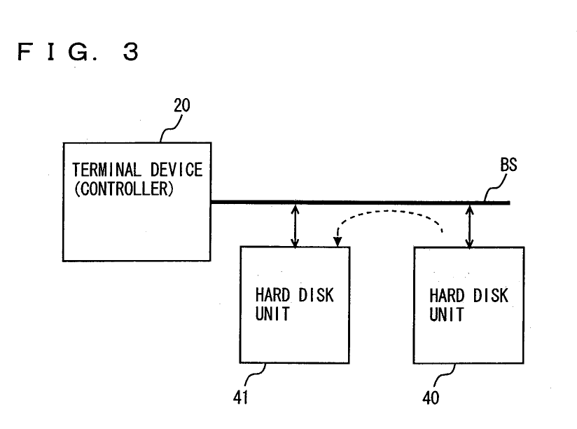

Further, the encrypted content data and the license recorded in hard disk unit 40 are sent to another hard disk unit. FIG. 3 schematically shows a structure, in which the encrypted content data and the license are sent between two hard disk units connected to data bus BS provided in terminal device 20.

A hard disk unit 41 having the same function as hard disk unit 40 is connected to data bus BS. A controller of terminal device 20 controls sending and receiving of the data between two hard disk units 40 and 41, and mediates the data. For sending the license, the secure connection is formed between hard disk units 40 and 41, and the license is sent via the secure connection thus formed. In this case, hard disk unit 40 authenticates the certificate of hard disk unit 41, and thereby determines the validity of hard disk unit 41.

In the case of sending and receiving the license between the two hard disks, the processing in hard disk unit 40, which is a sender of the license, will be referred to as “transfer”. The “transfer” can be classified into “shift” not remaining the license in the sender and “copy” remaining license in the sender. In the “transfer”, the shift or copy of the license is selected in accordance with the control information described in the license. The processing in hard disk unit 41, which is the receiver of the license, is write” and thus is the same as that in hard disk unit 40 shown in FIG. 1, and terminal device 20 and hard disk unit 40 function as content supply device 30 shown in FIG. 1, as will be described later in greater detail.

FIG. 3 shows the structure, in which two hard disk units 40 and 41 are connected to one terminal device 20. However, similar processing can be performed by a system, in which hard disk unit 41 is attached to a different terminal device, and terminal device 20 is connected to the different terminal device via a communication cable to allow data communication between the terminal devices.

For protecting the copyright of the content data, and allowing reproduction of the content data by a user for enjoyment in the above structure, the system first requires a manner itself for encrypting the content data, secondly requires a manner for preventing leakage of the license during license communication, and thirdly requires a manner of utilizing the license of the content data for preventing unauthorized copying and use of the content data, or a copyright protecting function restricting the copy.

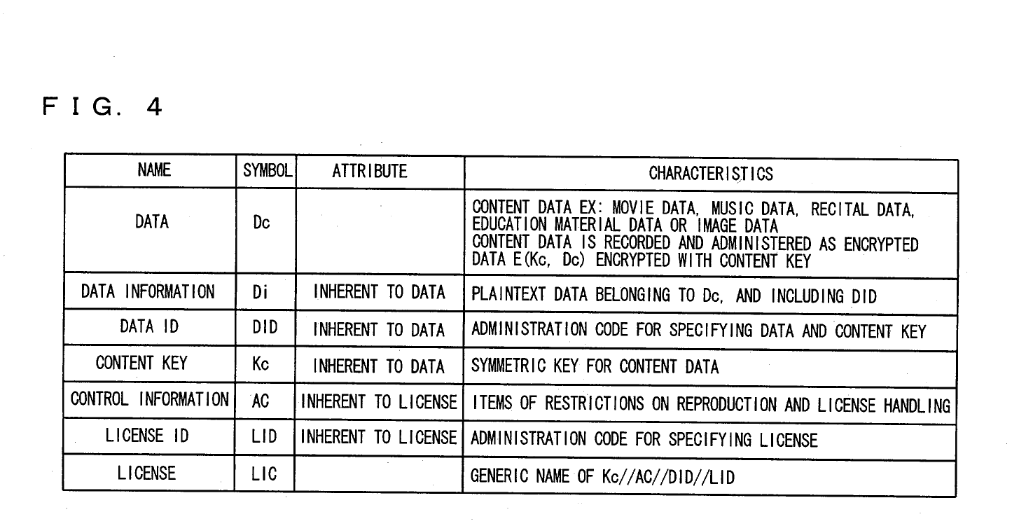

FIG. 4 illustrates characteristics of the data and licenses used in the invention.

First, description will be given on the data distributed from download server 10. Dc represents content data such as movie data. Content data Dc is encrypted into a form decryptable with content key Kc. Encrypted content data E(Kc, Dc), which is prepared by encryption into a form decryptable with content key Kc, is sent from download server 10 to the user of terminal device 20.

In the following description, an expression “E(X, Y)” represents that data Y is encrypted with encryption key X.

Together with the encrypted content data, download server 10 distributes additional information Di, which is plaintext information relating to the content data. Additional information Di includes data ID(DID) for identifying content data Dc.

As the license, there are content key Kc, a license ID (LID), a data ID (DID), control information AC and others.

Data ID is a code for identifying content data Dc, and license ID is a code for administering the distribution of the license from download server 10 and identifying individual license. Control information AC is employed for externally outputting the license or content key from the storing device (hard disk unit), and contains usage count (i.e., times of output of the license key for reproduction), restriction information relating to the shift and copy of the license and others.

The license ID, data ID, content key Kc and control information AC will be collectively referred to as a “license LIC” hereinafter.

For the sake of simplicity, it is assumed in the following description that control information AC includes only to two items, i.e., the usage count (0: usage disabled, 1-254: reproducible number of times, 255: no limitation), which are the control information for restricting the usage count, and a shift/copy flag (0: inhibiting shift/copy, 1: allowing only shift, 2: allowing shift/copy) for restricting the shift and copy of the license.

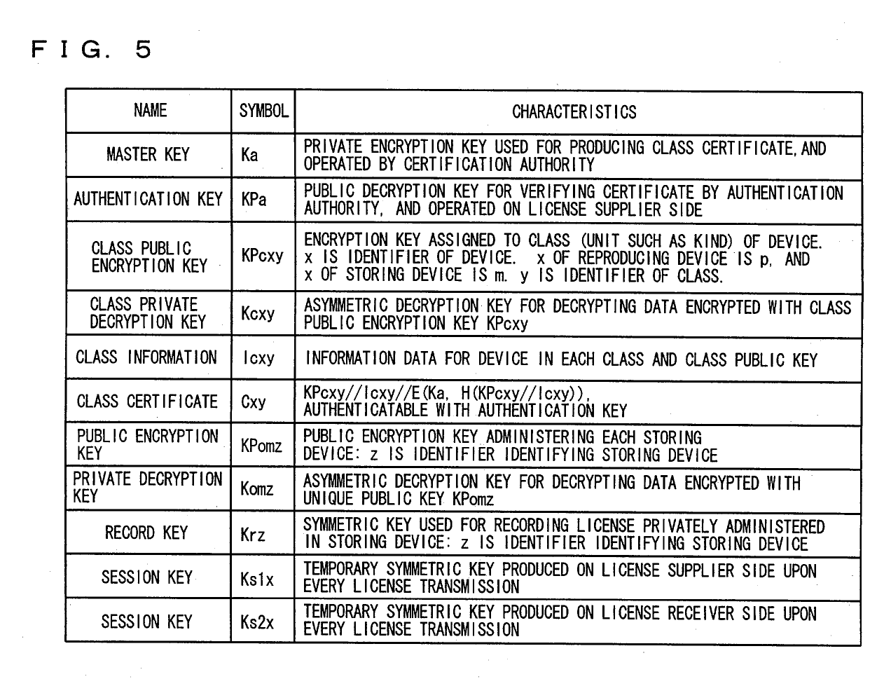

FIG. 5 illustrates characteristics of the data and keys used for the secure connection type in the invention.

Reproducing circuit 1550 in terminal device 20 as well as hard disk units 40 and 41 are provided with unique public encryption keys KPcxy, respectively. Public encryption key KPcxy is assigned to each of classes (predetermined units such as kinds) of the devices, and x is an identifier identifying the reproducing circuit and the storing device. If the device is a reproducing device such as a reproducing circuit, x is equal to p. If the device is a storing device such as a hard disk unit, x is equal to m. y is an identifier identifying the class of the device. Public encryption key KPcxy can be decrypted with private decryption key Kcxy. These public encryption key KPcxy and private decryption key Kcxy have values depending on the kinds such as a reproducing circuit and a hard disk unit. These public encryption key and private decryption key are collectively referred to as “class keys”. These public encryption key and private decryption key are referred to as a “class public encryption key” and a “class private decryption key”, respectively, and each unit commonly used by the class keys is referred to as a “class”. The class depends on manufacturing companies, kinds of products, production lots and others.

Cxy is provided as certificates of the hard disk unit and the reproducing circuit. These certificates have information depending on the class of the reproducing circuit and the hard disk unit.

Class certificates Cxy of the reproducing circuit and the hard disk unit are recorded in the reproducing circuit and the hard disk unit prior to shipping, and takes the form of KPcxy//lcxy//E(Ka, H(KPcxy//lcxy)), wherein lcxy is information data relating to the devices in the each class and to class public encryption key KPcxy. H(X) means a Hash value of X, which is a result of a Hash function effected on data string X, and X//Y means a coupling between X and Y. E(Ka, H(KPcxy//lcxy)) is signature data of KPcxy//lcxy.

KPa is a public authentication key, which is symmetric in the entire data distribution system, and is used for decrypting the signature data produced by encrypting class public encryption key KPcxy and class information lcxy with a master key Ka by a certification authority (not shown). Master key Ka is a private encryption key used for producing the signature data in the certificate by the certification authority.

Further, the system uses a public encryption key KPomz administered in each of the recording devices such as hard disk units 40 and 41, a private decryption key Komz allowing decryption of the data encrypted with public encryption key KPomz, and a record key Krz, which is used only in the recording device for recording the license to be administered privately. These public encryption key, private decryption key and record key, which are set for each hard disk unit, are generally referred to as unique keys. Also, public encryption key KPomz is referred to as a unique public encryption key, private decryption key Komz is referred to as a unique private decryption key, and record key Krz is referred to as a unique record key. z is a unique identifier identifying the recording device.

Every time the “write”, “transfer” or “usage permission” of the license is performed, symmetric keys Ks1w and Ks2w produced in download server 10, terminal device 20 and hard disk units 40 and 41 are used.

Symmetric keys Ks1w and Ks2w are generated in response to every session”, which is a unit of communication or access forming a secure connection in the communication between the download server, reproducing circuit and hard disk units, and are unique to each “session”. In the following description, these symmetric keys Ks1w and Ks2w are referred to as “session keys”. w is an identifier for identifying the session.

Session key Ks1w is generated by the supplier or sender providing the license, and session key Ks2w is generated by the destination or receiver receiving the license. More specifically, a license supply device (e.g., the download server) generates session key Ks1w, and the reproducing circuit generates session key Ks2w. When the “write” is performed in the hard disk unit, session key Ks2w is generated. When the “transfer” or “usage permission” is performed, session key Ks1w is generated. The session keys generated in each processing are exchanged.

Each device has a function of encrypting data with a session key, which is generated by another device, and decrypting the data, which is encrypted by another device with the session key generated by itself. As described above, the secure connection is formed using the session key, and the license is sent via the secure connection so that the security strength in the processing relating to the license can be improved, and the license can be protected from an attack on the communication.

According to the embodiment of the invention, a certificate revocation list CRL is operated so that it is possible to inhibit the provision of a new license or content key to a hard disk unit, of which security is no longer ensured due to a certain reason, by inhibiting on a class-by-class basis the licensing to the reproducing circuit, which is configured to reproduce the content in response to the licensing of the license. Certificate revocation list CRL is a data string formed of a list of information specifying certificate Cxy assigned to the class of the device, which is inhibited from receiving and using the license. Certificate revocation list CRL is held in the download server providing the license or hard disk unit. When the certificate, which is received for license provision and usage permission, is listed in certificate revocation list CRL, the download server stops the license provision, or the hard disk unit stops the “transfer” and “usage permission”.

The information specified by certificate Cxy uses a certificate number, which is described in certificate Cxy by the certification authority when certificate Cxy is issued. Therefore, listing of the certificate in certificate revocation list CRL is practically achieved by the fact that the certificate number of the certificate is mentioned in certificate revocation list CRL.

Certificate revocation list CRL must be appropriately updated. The updating of certificate revocation list CRL held in the download server is a major portion itself of the operation of download server 10, and therefore, it is apparent that download server 10 always holds latest certificate revocation list CRL. Therefore, description thereof is not repeated.

For updating certificate revocation list CRL held in the hard disk unit, the latest certificate revocation list CRL is sent together with the license when it is determined during the “write”, which is performed in response to the distribution of the license from download server 10, that certificate revocation list CRL held in the hard disk unit is not the latest list.

When hard disk unit receives the latest certificate revocation list CRL together with the license, received certificate revocation list CRL is written over certificate revocation list CRL held in the hard disk unit. For transmitting/receiving the license between the hard disk units, the hard disk unit on the license supplier side likewise provides certificate revocation list CRL to the hard disk unit on the receiver side.

Accordingly, certificate revocation list CRL includes date and time of update in addition to the certificate number of the class of the device, for which the license provision and usage permission are inhibited.

It has been described that the latest certificate revocation list CRL is provided for updating certificate revocation list CRL. However, a differential list for updating certificate revocation list CRL to the latest list may be provided based on the update date and time, and the hard disk unit may be configured to add the received differential list to certificate revocation list CRL held therein.

As described above, certificate revocation list CRL is held and operated not only in the download server but also in the hard disk unit. Thereby, the system inhibits the supply of the license to the reproducing circuit, terminal device and/or hard disk unit, of which decryption keys unique to the class (i.e., unique to the kind of the reproducing circuit and the hard disk unit) are leaked. Consequently, the reproducing circuit cannot reproduce the content corresponding to the license, of which usage permission is performed, and the hard disk unit can neither receive nor store a new license.

As described above, certificate revocation list CRL in the hard disk unit is appropriately updated in accordance with provision of the license. Consequently, the possibility of leakage of the license is eliminated, and the copyright can be protected more reliably.

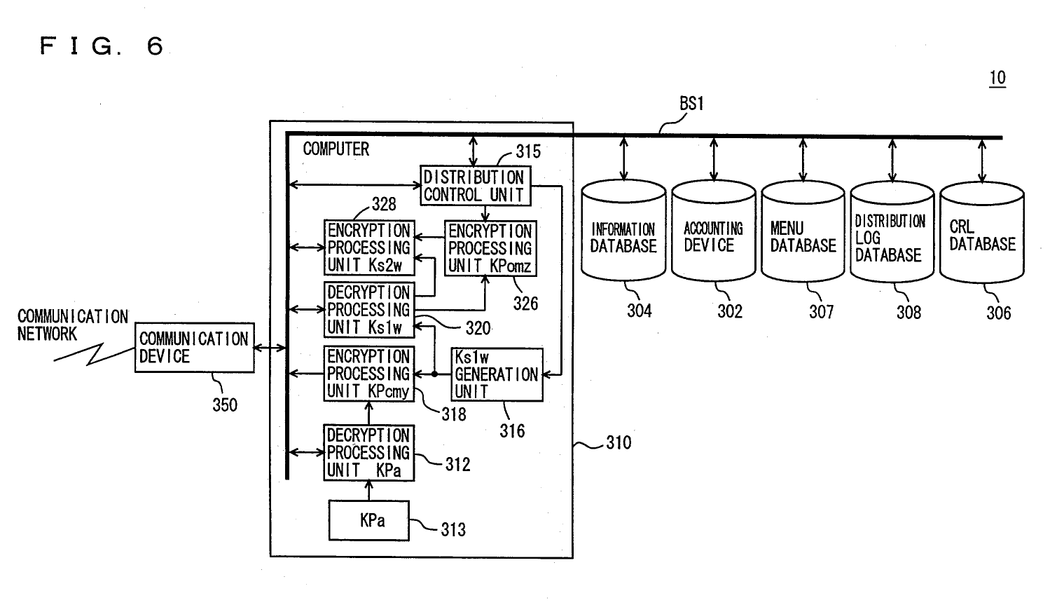

FIG. 6 is a schematic block diagram illustrating a structure of download server 10.

Download server 10 includes an information database 304 for holding distribution information such as data, which is prepared by encrypting the content data in accordance with a predetermined manner, and a data ID, an accounting database 302 for holding accounting information according to the start of access to content data for each of the users of the terminal devices such as cellular phones and others, a CRL database 306 for administering certificate revocation lists CRL, a menu database 307 for holding the menu of content data held in information database 304, a distribution log database 308 for holding a log, which is produced in response to every distribution of the license and relates to distribution of the license ID and others specifying the license, a data processing unit 310 for receiving data via a bus BS1 from information database 304, accounting database 302, CRL database 306, menu database 307 and distribution log database 308, and performing predetermined processing, and a communication device 350 for transmitting data between a distribution carrier and data processing unit 310 over the communication network.

Data processing unit 310 includes a distribution control unit 315 for controlling an operation of data processing unit 310 in accordance with the data on bus BS1, a session key generating unit 316 which is controlled by distribution control unit 315 to generate session key Ks1w during the distribution processing, an authentication key holding unit 313 holding authentication key KPa, which is a public decryption key for decrypting authentication data Cxy=KPcxy//lcxy//E(Ka, H(KPcxy//lcxy)) sent from the hard disk unit for authentication, a decryption processing unit 312, which receives authentication data Cxy sent for authentication from the hard disk unit via communication device 350 and bus BS1, and decrypts it with authentication key KPa sent from authentication key holding unit 313, an encryption processing unit 318, which encrypts session key Ks1w generated by session key generating unit 316 with class public encryption key KPcxy obtained by decryption processing unit 312, and provides it onto bus BS1, and a decryption processing unit 320 for receiving the data, which is sent after being encrypted with session key Ks1w, and decrypting it with session key Ks1w.

Data processing unit 310 further includes an encryption processing unit 326 for encrypting content key Kc and control information AC, which are provided from distribution control unit 315, with unique public encryption key KPomz of the hard disk unit, which is obtained by decryption processing unit 320, as well as an encryption processing unit 328 for further encrypting the output of encryption processing unit 326 with session key Ks2w provided from decryption processing unit 320, and outputting it onto bus BS1.

Operations in the distribution processing of download server 10 will be described later in greater detail with reference to flow charts.

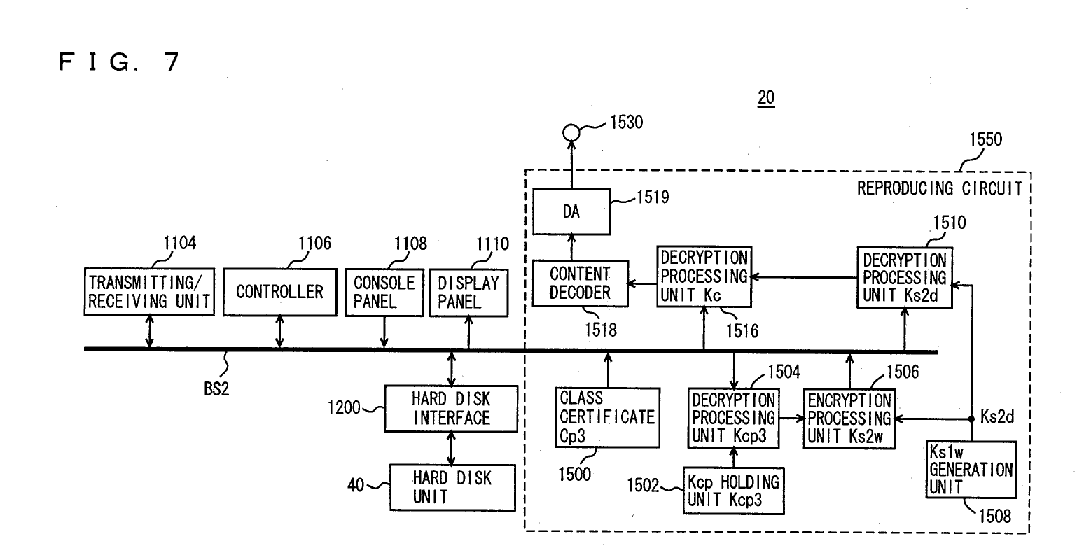

FIG. 7 is a schematic block diagram showing a structure of terminal device 20, which has a function for connection to download server 10 shown in FIGS. 1 and 2, and is provided with reproducing circuit 1550.

Terminal device 20 includes a transmitting/receiving unit 1104 connected to download server 10 over the digital communication network for transmitting/receiving data, a bus BS2 for transmitting/receiving data between various units in terminal device 20, a controller 1106 for controlling the operation of terminal device 20 via bus BS2, an console panel 1108 for providing an external instruction to terminal device 20, and a display panel 1110 for providing information sent from controller 1106 and others to the user as visual information.

Terminal device 20 further includes hard disk unit 40, which is removably attached for storing and decrypting content data (music data) from download server 10, a hard disk interface 1200 controlling transmission/reception of data between hard disk unit 40 and bus BS2, and reproducing circuit 1550.

Reproducing circuit 1550 includes a certificate holding unit 1500 holding a certificate Cp3=KPcp3//lcp3//E(Ka, H(KPcp3//lcp3)). In this case, class y of terminal device 20 is equal to three (y=3).

Reproducing circuit 1550 further includes a Kcp holding unit 1502 holding key Kcp3, which is a decryption key unique to the class, and a decryption processing unit 1504, decrypting the data received from bus BS2 to obtain session key Ks1w generated by hard disk unit 40.

Reproducing circuit 1550 further includes a session key generating unit 1508, generating session key Ks2w based on a random number or the like, and an encryption processing unit 1506, encrypting session key Ks2w generated by session key generating unit 1508 with session key Ks1w produced by hard disk unit 40 and obtained by decryption processing unit 1504, and outputs it onto bus BS2.

Reproducing circuit 1550 further includes a decryption processing unit 1510, decrypting the data on bus BS2 with session key Ks2w to output content key Kc, and a decryption processing unit 1516, receiving encrypted content data E(Kc, Dc) from bus BS2, and decrypting it with content key Kc provided from decryption processing unit 1510 to output decrypted content data Dc to a content decoder 1518.

Reproducing circuit 1550 further includes content decoder 1518 receiving the output of decryption processing unit 1516, and reproducing a movie from content data Dc, a D/A converter 1519 converting the output of content decoder 1518 from digital signals to analog signals, and a terminal 1530 for providing the output of D/A converter 1519 to an external output device such as headphones (not shown).

Hard disk interface 1200 is an interface based on ATA (AT Attachment) standards. Therefore, bus BS is ATA bus.

Operations in processing of various units of terminal device 20 will be described later in greater detail with reference to flow charts.

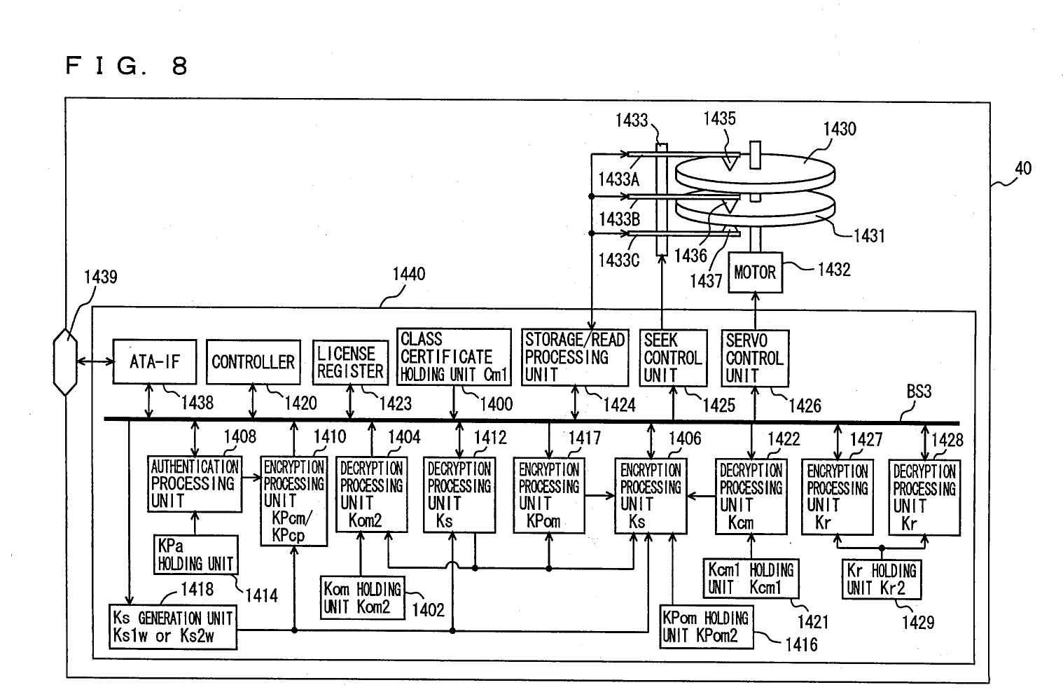

Referring to FIG. 8, hard disk unit 40 includes hard disks 1430 and 1431, a motor 1432, arms 1433A-1433C, a support 1433, heads 1435-1437, a terminal 1439 and a control unit 1440.

Hard disks 1430 and 1431 are formed of disk-like record mediums for magnetically recording data. Motor 1432 rotates hard disks 1430 and 1431 at a predetermined rotation speed. Arms 1433A-1433C are fixed to support 1433. Head 1435 is fixed to an end of arm 1433A for storing and/or reading data on and/or from one of the surfaces of hard disk 1430. Head 1436 is fixed to an end of arm 1433B for storing and/or reading data on and/or from the other surface of hard disk 1430 and one of the surfaces of hard disk 1431. Head 1437 is fixed to an end of arm 1433C for storing and/or reading data on and/or from the other surface of hard disk 1431. Terminal 1439 is provided for sending and receiving data to and from hard disk interface 1200 of terminal device 20.

As already described, keys KPcmy and Kcmy are employed as class public encryption key and class private decryption key of hard disk unit 40, and certificate Cmy=KPcmy//lcmy//E(Ka, H(KPcmy//lcmy)) of the hard disk unit is employed. In hard disk unit 40, class identifier y is equal to one (y=1), and unique identifier z identifying the hard disk unit is equal to two (z=2).

Accordingly, control unit 1440 includes a certificate holding unit 1400 holding certificate Cm1=KPcm1//lcm1//E(Ka, H(KPcm1//lcm1)), a Kom holding unit 1402 holding a unique private decryption key Kom2, which is a decryption key set uniquely to each hard disk unit, a Kcm holding unit 1421 holding a class private decryption key Kcm1, and a KPom holding unit 1416 holding public encryption key KPom2 allowing decryption with unique private decryption key Kom2.

As described above, by providing the encryption keys of the storing devices such as hard disk units, the distributed content data and the encrypted content key can be administered for each hard disk unit independently of the other hard disk unit.

Control unit 1440 further includes an ATA (AT Attachment) interface 1438 for transmitting/receiving data to and from hard disk interface 1200 via terminal 1439, a bus BS3 transmitting/receiving signals to and from ATA-interface 1438, a decryption processing unit 1422 operating in the “write” of the license to decrypt session key Ks1w, which is produced by a different device (i.e., a supplier of the license) and is encrypted with class public encryption key KPcm1 provided from ATA-interface 1438 onto bus BS3, with class private decryption key Kcm1 provided from Kcm holding unit 1421, and provides session key Ks1w produced by the different device to an encryption processing unit 1406, an authentication processing unit 1408 operating in the “transfer” or “usage permission” of the license to perform the authentication processing by determining the certificate of another device based on authentication key KPa received from KPa holding unit 1414, to provide the result of authentication and the certificate number obtained from the certificate to controller 1420 and to provide the class public encryption key of the different device obtained from the certificate to encryption processing unit 1410, and encryption processing unit 1406, encrypting the data with session key Ks1w provided from a decryption processing unit 1422 in the “write” and further with session key Ks2w provided from a decryption processing unit 1412 in the “transfer” or the “usage permission”, and outputs it onto bus BS3.

Control unit 1440 further includes a session key generating unit 1418, generating session key Ks2w in the “write” of license, and generating session key Ks1w in the “transfer” and “usage permission”, encryption processing unit 1410, encrypting session key Ks1w generated from session key generating unit 1418 with class public encryption key KPcpz or KPcmz obtained by authentication processing unit 1408, and sending it onto bus BS3, and a decryption processing unit 1412 receiving data, which is encrypted with session key Ks1w or Ks2w generated by session key generating unit 1418, via bus BS3 and decrypting it with session key Ks1w or Ks2w obtained from session key generating unit 1418.

In the “write” of license, decryption processing unit 1412 receives license LIC, which is encrypted with unique public encryption key KPom2, and is further encrypted with session key Ks2w, and decrypts it with session key Ks2w to obtain license LIC encrypted with unique public encryption key KPom2. In the “transfer” of license, decryption processing unit 1412 receives session key Ks2w generated by the different hard disk unit, which is a supplier of the license encrypted with session key Ks1w, and unique public encryption key KPomz (z≠2) of the different hard disk unit, and decrypts them with session key Ks1w to obtain unique public encryption key KPomz (z≠2) of the different hard disk unit and session key Ks2w generated by the different hard disk unit.

Further, in the “usage permission” of the license, decryption processing unit 1412 receives session key Ks2w generated by a reproducing circuit, which is a receiver of content key Kc encrypted with session key Ks1w, and decrypts it with session key Ks1w to obtain session key Ks1w produced by the reproducing circuit.

Control unit 1440 further includes a Kr holding unit 1429 holding unique record key Krz (z=2), which is a symmetric key unique to the hard disk unit, and is used for encrypting license LIC when recording license LIC on the record mediums (i.e., hard disks 1430 and 1431) so that the security of license LIC stored on hard disks 1430 and 1431 may be ensured, an encryption processing unit 1427 operating in the “write” of the license (i.e., when storing license LIC on hard disks 1430 and 1431) to encrypt license LIC to be stored with unique record key Kr2 provided from Kr holding unit 1429, and to provide it to a storage/read processing unit 1424 via bus BS3, a decryption processing unit 1428 operating in the “transfer”0 or the “usage permission” of the license (i.e., for reading license LIC, which is stored on hard disks 1430 and 1431 and is encrypted with unique record key Ki2), to decrypt license LIC, which is received from storage/read processing unit 1424, and is encrypted with unique record key Kr2, with unique record key Kr2 provided from Kr holding unit 1429, and to provide it onto bus BS3, and an encryption processing unit 1417 operating in the “transfer” of the license to encrypt license LIC, which is read from hard disks 1430 and 1431, and is decrypted by decryption processing unit 1428, and encrypts it with unique public encryption key KPomz (z≠2) of a different hard disk unit decrypted by decryption processing unit 1412.

Control unit 1440 further includes a decryption processing unit 1404 decrypting the data on bus BS3 with unique private decryption key Kom2 of hard disk unit 40 paired with unique public encryption key KPom2, a license register 1423 operating in the “write” of the license to hold temporarily license LIC, which is received from download server 10 or a different hard disk unit (i.e., a supplier of the license) and is decrypted by decryption processing unit 1404, and operating in the “transfer” and the “usage permission” to store temporarily license LIC, which is read from hard disks 1430 and 1431, and is decrypted by decryption processing unit 1428, storage/read processing unit 1424 storing and/or reading the data into and/or from hard disks 1430 and 1431 via heads 1435-1437 fixed to respective arms 1433A-1433C, a seek control unit 1425 for seeking arms 1433A-1433C in a radial direction of hard disks 1430 and 1431, and a servo control unit 1426 controlling motor 1432 to rotate at a predetermined rotation speed.

Control unit 1440 further includes controller 1420, externally transmits/receives data via bus BS3, receives control information AC from bus BS3 and controls the operation of hard disk unit 40.

Hard disk unit 40 includes two hard disks 1430 and 1431. When the data is stored on and/or read from hard disks 1430 and 1431, these storing and/or reading are not performed successively one by one in such a manner that the storing or reading of data is first performed on or from hard disk 1430, and then is performed on or from hard disk 1431. Alternatively, the storing and/or reading are performed in such a manner that the plurality of heads 1435-1437 simultaneously move to the same position, and simultaneously perform the storing and/or reading at this same position. Accordingly, two hard disks 1430 and 1431 form one data storage region as a whole.

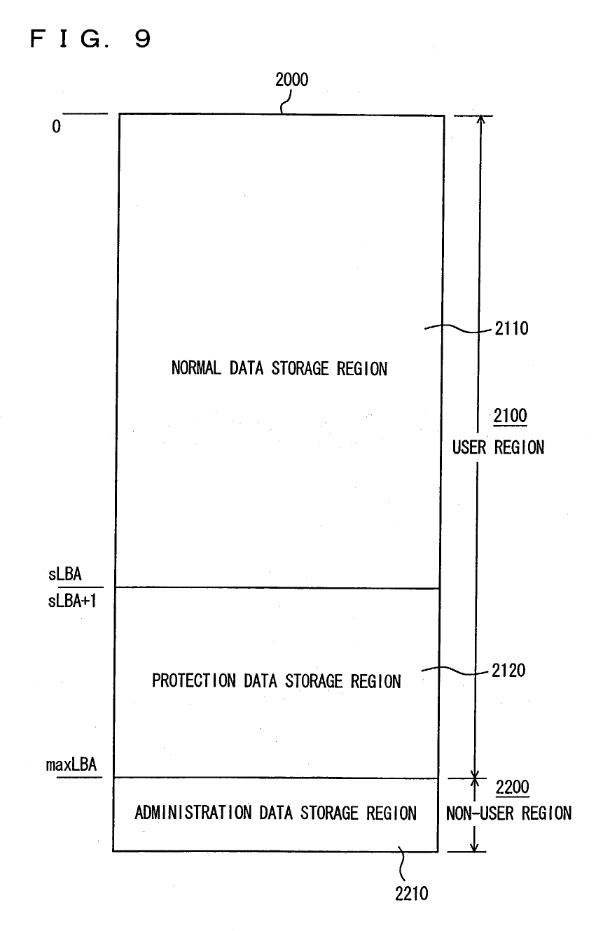

FIG. 9 shows by way of example logical addresses in a data storage region formed of the whole of hard disks 1430 and 1431. A record position on the hard disk is designated by a logical address called “LBA (Logical Block Address)”. Referring to FIG. 9, a data storage region 2000 includes a user region 2100 and a non-user region 2200. User region 2100 is formed of a normal data storage region 2110 and a protection data storage region 2120. Non-user region 2200 is formed of an administration data storage region 2210.

Normal data storage region 2110 allows direct storing and/or reading of the data in accordance with standard commands of ATA commands, i.e., write/read commands (WRITE DMA/WRITE PIO/READ DMA/READ, PIO), and data is stored in and/or read from a storage block designated by a logical address called “LBA”.

Protection data storage region 2120 is a region recording license LIC. Protection data storage region 2120 does not allow direct storing and reading of data in accordance with the write/read commands to be the standard commands of ATA commands, but allows storing and/or reading of the license after a secure connection is formed to a device, which is allowed in advance, in accordance with predetermined procedures of performing the “write”, “transfer” or “usage permission” of the license.

The storage position is designated in accordance with LBA similarly to normal data storage region 2110. The data stored in protection data storage region 2120 is stored in a form encrypted with unique record key Kr2 so that the stored data cannot be referred to even when hard disk unit 40 is opened and hard disks 1430 and 1431 are detached. Thereby, the security on the record medium is ensured.

When storing and/or reading data on and/or from user region 2100, controller 1420 operates such that one physical address is necessarily present corresponding to one LBA, although the physical address received via ATA-interface 1438 does not necessarily match with the logical address.

Assuming that “maxLBA” is a natural number and thus satisfies a relationship of (0<maxLBA), storage blocks of (maxLBA+1) in number corresponding to logical address LBA from 0 to maxLBA are assigned to user region 2100. Assuming that “sLBA is a natural number satisfying a relationship of (0<sLBA ≦maxLBA), blocks of (sLBA+1) in number arranged at and between a leading position (LBA=0) and a position of LBA=sLBA form normal data storage region 2110, and each storage block can store data of 512 bytes. The remaining blocks in user region 2100, i.e., the storage blocks of (maxLBA-sLBA) in number located at and between the position of LBA=(sLBA+1) and the final position (LBA=maxLBA) form protection data storage region 2120, and each stores one license.

The “maxLBA” representing the final LBA in user region 2100 represents a maximum value of LBA, which can be designated by the user in hard disk unit 40, and is determined depending on hard disk unit 40. “sLBA”, which represents a boundary between normal data storage region 2110 and protection data storage region 2120, is designated in the processing of initializing hard disk unit 40 to determine a formation ratio between normal and protection data storage regions 2110 and 2120.

In view of the purpose of use of hard disk unit 40 (e.g., in view of the kind of content to be recorded), the storage regions can be configured as follows. For example, when a relatively small amount of content data such as music data is to be recorded, the number of licenses, which can be stored in protection data storage region 2120, are increased, and the data storage capacity of normal data storage region 2110 recording the encrypted content data is reduced. When a large amount of content such as movie data is to be recorded, the number of licenses, which can be stored in protection data storage region 2120, are reduced, and the data storage capacity of normal data storage region 2110 recording the encrypted content data is increased.

A region other than normal data storage region 2110 is assigned to administration data storage region 2210. This region stores administration data to be used uniquely in hard disk unit 40, and therefore the logical address is not assigned thereto. Administration data storage region 2210 stores administration and control information in the hard disk unit (i.e., a conversion table of physical addresses assigned to user region 2100 and logical addresses, or an error log), information (e.g., administration table and certificate revocation list CRL) relating to processing effected on protection data storage region 2120, and unit information (e.g., maxLBA, sLBA and a set range of sLBA), which relates to use of the hard disk unit, and is to be provided to terminal device 20. Further, administration data storage region 2210 stores a part of a program of controller 1420. Since administration data storage region 2210 is formed of storage blocks kept for internally administering hard disk unit 40 by controller 1420, the data in administration data storage region 2210 can be neither stored nor read via ATA-interface 1438. Thus, the user cannot directly designate it by logical address LBA.

In FIG. 9, the logical addresses LBA assigned to protection data storage region 2120 follow the logical addresses LBA assigned to normal data storage region 2110. However, the logical addresses LBA can be assigned to protection data storage region 2120 in any of the manners other than the above. For example, the storage regions may be arranged in the order of the normal data storage region, protection data storage region and the normal data storage region. This can be achieved by designating the start LBA and the end LBA of the protection data storage region.

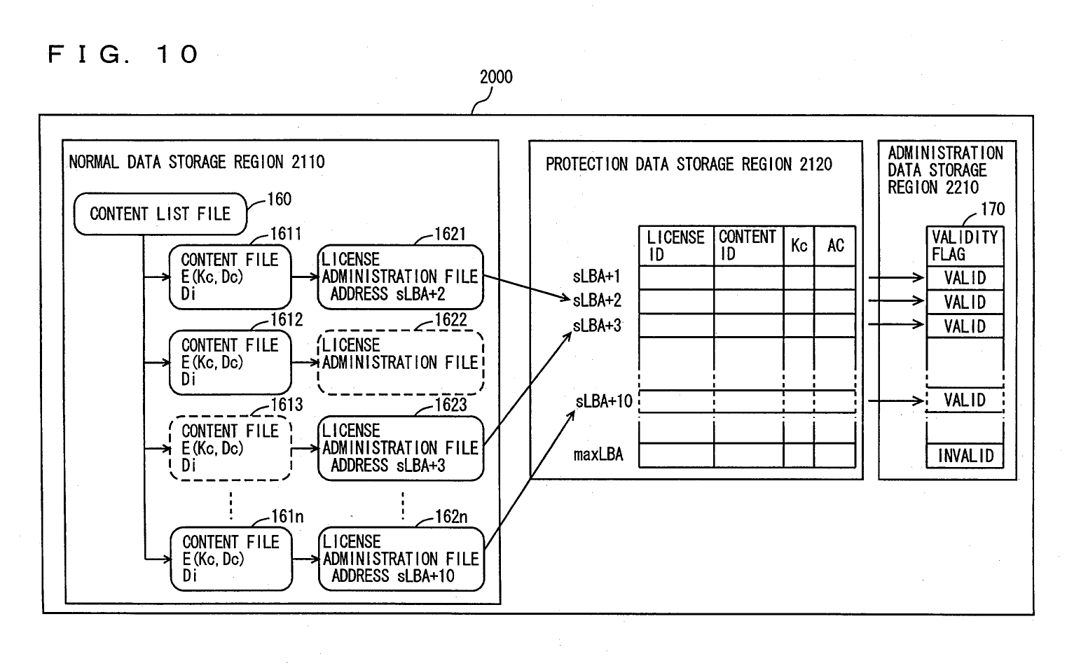

FIG. 10 illustrates a manner of storing the content in the hard disk unit. Referring to FIG. 10, protection data storage region 2120 is formed of storage blocks of (maxLBA-sLBA) in number each storing one license. Each storage block can store license ID, content ID, content key Kc and control information AC forming license LIC. Administration data storage region 2210 stores an administration table 170 bearing validity flags indicating validities of the licenses recorded in the respective storage blocks of protection data storage region 2120. Administration table 170 stores validity flags of (maxLBA-sLBA) in number corresponding to all logical addresses LBA assigned to protection data storage region 2120. Controller 1420 rewrites the validity flag in response to every change in the storage state of the license, which is recorded at the logical address LBA corresponding to the validity flag by the “write” or “transfer” of the license. The validity flag is control information for inhibiting output of the license recorded at the LBA when the shift of the license is selected in the “transfer” of the license, and is used for safely erasing the license in the sender, from which the license is moved.

A content file 1611 will now be described. Encrypted content data E(Kc, Dc) is stored in content file 1611. The license is stored at a license storage position of (sLBA+2), which can be seen by referring to a license administration file 1621 corresponding to content file 1611. It can be determined that the validity flag in administration table 170, which corresponds to LBA of (sLBA+2) in protection data storage region 2120, is “valid”, and it can be confirmed that the license is stored. Accordingly, content key Kc is provided to reproducing circuit 1550 in accordance with the “usage permission” of the license stored at LBA of (sLBA+2), and content file 1611 is read in accordance with only the ATA standard command, and is provided to reproducing circuit 1550. Thereby, the content can be reproduced for enjoyment.

A content file 1613 is depicted by broken line, which means that content file 1613 is not stored in normal data storage region 2110. However, a license administration file 1623 corresponding to content file 1613 is depicted by solid line, and is stored in normal data storage region 2110. Storing position sLBA+3 of license is stored in license administration file 1623. Therefore, controller 1106 of terminal device 20 determines that only the license is present. At LBA of (sLBA+3) in protection data storage region 2120, the corresponding validity flag in administration table 170 is “valid”, and only the license is stored in hard disk unit 40. In this case, the user of hard disk unit 40 can enjoy the content again merely by acquiring encrypted content data E(Kc, Dc). This situation occurs, e.g., when the encrypted content data E(Kc, Dc) is saved in another record medium due to an insufficient storage capacity of normal data storage region 2110 in hard disk unit 40.

Conversely, a license administration file 1622 stores “no license”. Thus, corresponding license LIC is not stored in hard disk unit 40. This situation occurs when the shift of the license is selected in the “transfer” of the license, or when encrypted content data E(Kc, Dc) and additional information Di to be stored in the content file are obtained in advance via a distribution path other than that for the license.

Operations in the processing illustrated in FIGS. 1-3 will now be described.

[Whole Processing]

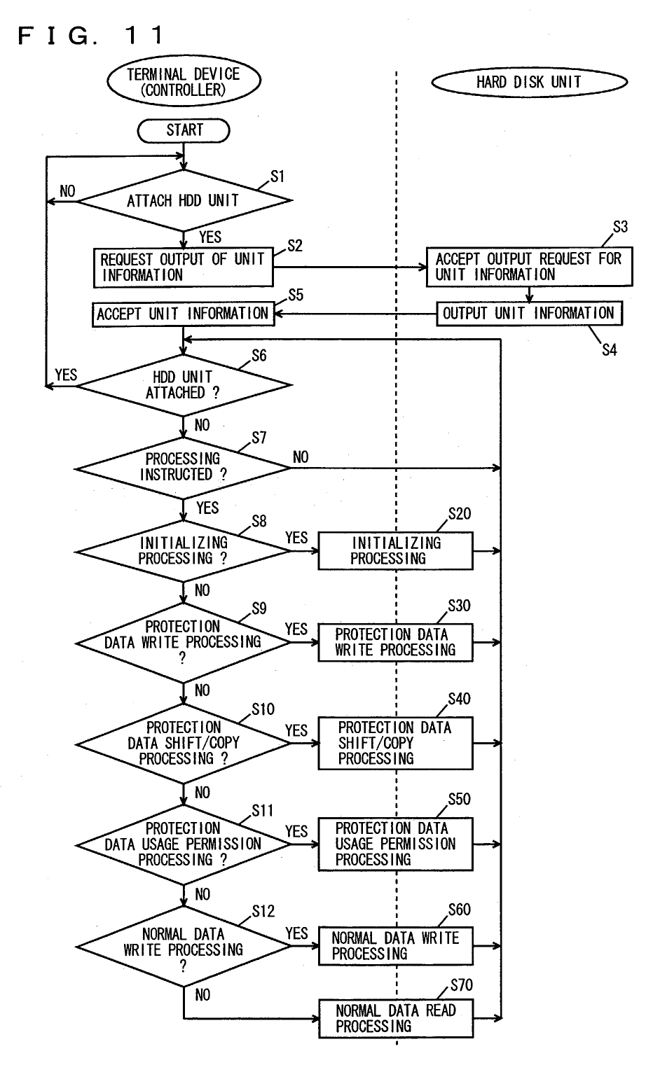

FIG. 11 is a flow chart illustrating a flow of processing relating to hard disk unit 40 in terminal device 20.

When the operation starts, controller 1106 of terminal device 20 determines whether hard disk unit 40 is attached or not (step S1). When hard disk unit 40 is not attached, step S1 will be repeated until hard disk unit 40 is attached. When it is determined in step S1 that hard disk unit 40 is attached, controller 1106 issues a request for output of unit information to hard disk unit 40 via bus BS2 and hard disk interface 1200 (step S2).

Controller 1420 of hard disk unit 40 accepts the request for output of the unit information via terminal 1439, ATA-interface 1438 and bus BS3 (step S3), and controller 1420 controls storage/read processing unit 1424, seek control unit 1425 and servo control unit 1426 to read the unit information from administration data storage region 2210 of hard disks 1430 and 1431. Thereby, servo control unit 1426 controls motor 1432 to rotate at a predetermined rotation speed so that motor 1432 rotates hard disks 1430 and 1431 at the predetermined rotation speed. Seek control unit 1425 controls arms 1433A-1433C to seek to administration data storage region 2210 of hard disks 1430 and 1431, and storage/read processing unit 1424 reads the unit information from administration data storage region 2210, and provides the unit information thus read onto bus BS3. Controller 1420 provides the unit information on bus BS3 via ATA-interface 1438 and terminal 1439 to hard disk interface 1200 (step S4).

Controller 1106 of terminal device 20 accepts the unit information of hard disk unit 40 via hard disk interface 1200 and bus BS2 (step S5). The unit information includes two kinds of information. One of them is information for determining whether hard disk unit 40 has a protection function or not. The other is the information required for utilizing hard disk unit 40 in the case where hard disk unit 40 has the protection function, and relates to, e.g., address spaces designating normal data storage region 2110 and protection data storage region 2120, or a movable range of the boundary between these regions 2110 and 2120 as well as the encryption manner. Thereafter, controller 1106 determines whether the removing and attaching of hard disk unit 40 are instructed via console panel 1108 or not (step S6). When the removing and attaching of hard disk unit 40 are instructed, steps S1-S6 are repeated. When the removing and attaching of hard disk unit 40 are not instructed in step S6, controller 1106 determines whether the user entered via console panel 1108 the instructions of processing such as initializing processing, protection data write processing, protection data move/duplicate processing, usage permission processing of the protection data and normal data write processing or not (step S7). When no processing is instructed, the operation returns to step S6.

When it is determined in step S7 that one of these processing is instructed, controller 1106 determines whether the initializing processing is to be performed or not (step S8). When the initializing processing is to be performed, controller 1106 instructs hard disk unit 40 to perform initializing processing (step S20). When the processing of initializing hard disk unit 40 ends, the operation returns to step S6. This initializing processing will be described later in greater detail. When the initializing processing is not to be performed in step S8, controller 1106 determines whether the protection data write processing is to be performed or not (step S9). When the protection data write processing is to be performed, the processing of writing the protection data into hard disk unit 40 is performed (step S30). When the processing of writing the protection data into hard disk unit 40 ends, the operation returns to step S6. The protection data write processing will be described later in greater detail.

When it is determined in step S9 that the protection data write processing is not to be performed, controller 1106 determines whether the processing of moving/duplicating the protection data is to be performed or not (step S10). When the processing of moving/duplicating the protection data is to be performed, the processing is performed to move or duplicate the protection data from hard disk unit 40 to another hard disk unit (step S40). When the processing of moving/duplicating the protection data ends, the operation returns to step S6. The processing of moving/duplicating the protection data will be described later in greater detail.

When it is determined in step S 10 that the processing of moving/duplicating the protection data is not to be performed, controller 1106 determines whether the usage permission of the protection data is to be performed or not (step S11). When the usage permission of the protection data is to be performed, the usage permission of the license stored in hard disk unit 40 is performed (step S50). When the usage permission of the license ends, the operation returns to step S6. The usage permission processing will be described later in greater detail.

When it is determined in step S11 that the usage permission processing of the protection data is not to be performed, controller 1106 determines whether the normal data write processing is to be performed or not (step S12). When the normal data write processing is to be performed, processing is performed to write the normal data into hard disk unit 40 (step S60). When the normal data write processing ends, the operation returns to step S6. The normal data write processing will be described later in greater detail.

When it is determined in step S12 that the write processing of the normal data is not to be performed, controller 1106 performs the processing of reading the normal data from hard disk unit 40 (step S70). When the normal data read processing ends, the operation returns to step S6. The normal data read processing will be described later in greater detail. The processing for the protection data is the processing effected on license LIC, which is stored or is to be stored in protection data storage region 2120. The processing for the normal data is the processing effected on the data, which is stored or is to be stored in normal data storage region 2110, and more specifically, is the processing effected on the content list file, content file, license administration file or the like stored in normal data storage region 2110.

[Initializing Processing]

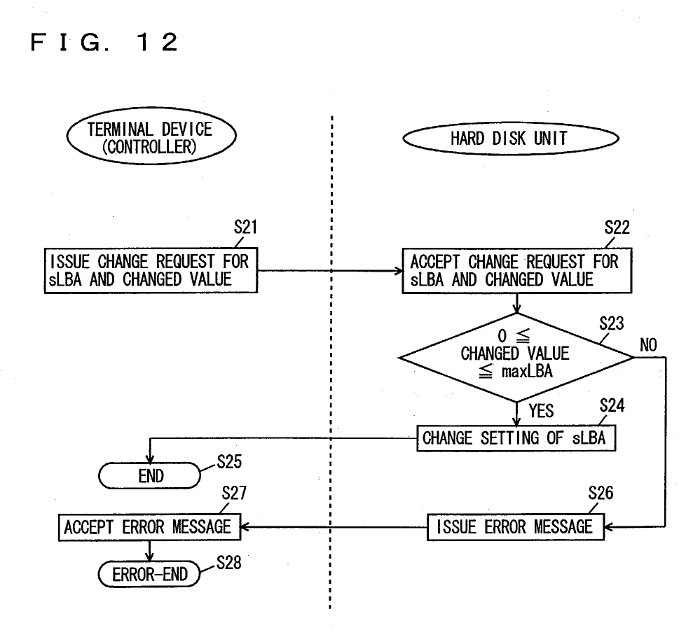

Description will now be given on the initializing processing (step S20) in a flow chart of FIG. 11. FIG. 12 is a flow chart for illustrating more specifically the initializing processing in the flow chart of FIG. 11.

Referring to FIG. 12, description will be given on the processing of initializing hard disk unit 40. When the initializing processing starts, controller 1106 of terminal device 20 determines a changed value within the set range of sLBA, which is obtained as the unit information, according to a predetermined calculation formula, and provides the change request and the changed value of the boundary between normal data storage region 2110 and protection data storage region 2120 to hard disk unit 40 via bus BS2 and hard disk interface 1200 (step S21). The set range of sLBA is from 0 to maxLBA.

Thereby, controller 1420 of hard disk unit 40 accepts the boundary change request and the changed value via terminal 1439, ATA-interface 1438 and bus BS3 (step S22), and determines whether the accepted changed value falls within the set range of sLBA included in the unit information, i.e., in the range from 0 to maxLBA (step S23). When it is determined in step S23 that the changed value falls within the range of addresses of 0-maxLBA, controller 1420 changes sLBA, which indicates the boundary between normal data storage region 2110 and protection data storage region 2120, to the accepted changed value (step S24). More specifically, controller 1420 operates to overwrite the unit information stored in administration data storage region 2210 of hard disks 1430 and 1431. For this purpose, controller 1420 instructs seek control unit 1425 to move heads 1435-1437 to positions over the record block storing the unit information, provides data corresponding to the storage block and required for overwriting the value of sLBA included in the stored unit information with the changed value, and instructs the storage of the data. Storage/read processing unit 1424 overwrites the value of sLBA, which is included in the unit information stored in administration data storage region 2210, with the changed value via arms 1433A-1433C and heads 1435-1437. Thereby, the initializing processing ends normally (step S25).

When it is determined in step S23 that the changed value exceeds the range of addresses from 0 to maxLBA, controller 1420 issues an error message via bus BS3, ATA-interface 1438 and terminal 1439 to hard disk interface 1200 (step S26), and controller 1106 of terminal device 20 accepts the error message via hard disk interface 1200 and bus BS2 (step S27) so that the initializing processing ends due to an error (step S28).

Protection data storage region 2120 can be changed within a range of user region 2100. Therefore, it is determined in step S23 whether the changed value of address sLBA provided from terminal device 20 falls within the range of changeable addresses of 0-maxLBA. When it falls within the range, setting of address sLBA is changed. When the changed value exceeds the changeable range, the error message is issued, and the initializing processing ends according to the structure described above.

According to the distinctive feature of the invention, as described above, protection data storage region 2120 in user region 2100 of hard disks 1430 and 1431 has the changeable storage region for storing the classified data such as a license, of which security must be ensured.

In the flow chart shown in FIG. 12, the value of final logical address sLBA of normal data storage region 2110 is changed for changing the boundary between normal data storage region 2110 and protection data storage region 2120. However, the invention is not restricted to this, and protection data storage region 2120 can be changed by instructing the change of the start logical address of protection data storage region 2120. Also, protection data storage region 2120 can be changed by designating the number of license stored in protection data storage region 2120, i.e., the number of storage blocks of protection data storage region 2120. Likewise, normal data storage region 2110 can be changed by designating the number of storage blocks of normal data storage region 2110.

In any one of the foregoing instructing manners, hard disk unit 40 is merely required to have a function, which allows external designation for assigning the storage blocks in user-available user region 2100 to normal data storage region 2110 and protection data storage region 2120 so that these regions 2110 and 2120 may be divided appropriately in accordance with the purpose of use on hard disks 1430 and 1431 of hard disk unit 40.

Hard disk unit 40 is merely required to output externally, as the unit information, the state of assignment or allocation of the storage blocks to normal data storage region 2110 and protection data storage region 2120. By obtaining the unit information from hard disk unit 40, terminal device 20 can detect logical address LBA assigned to normal data storage region 2110 and protection data storage region 2120. Further, it is simply required that the setting range of parameters assigned to normal data storage region 2110 and protection data storage region 2120 can be externally output as the unit information.

[Distribution Processing]

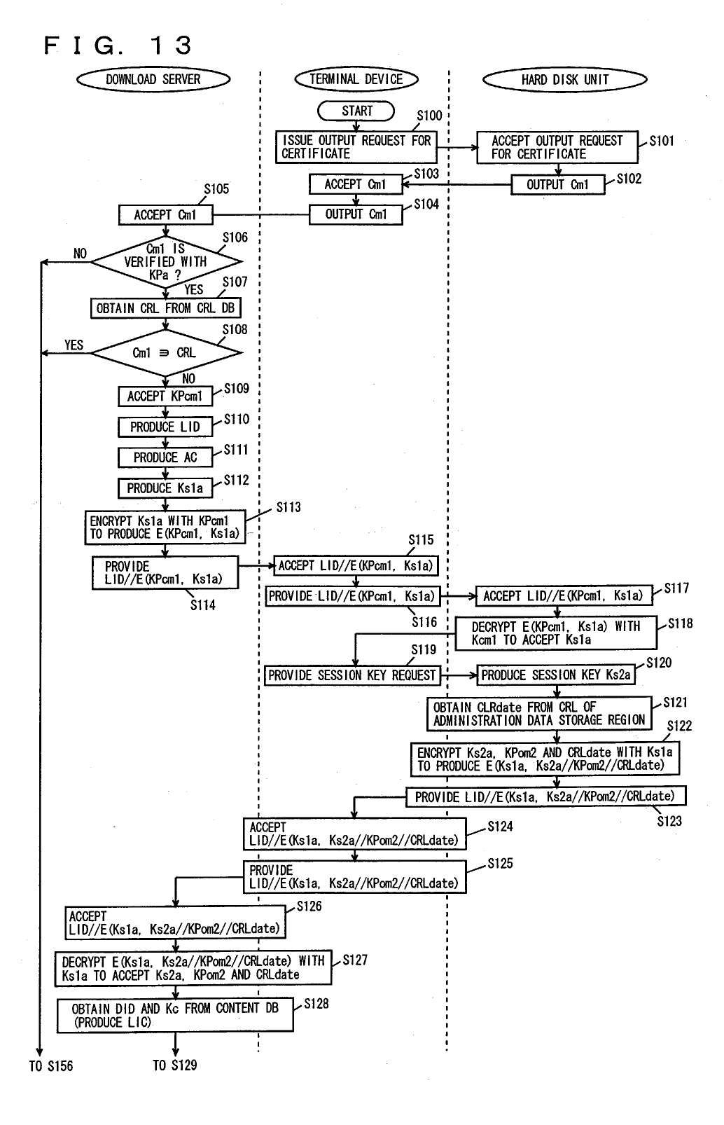

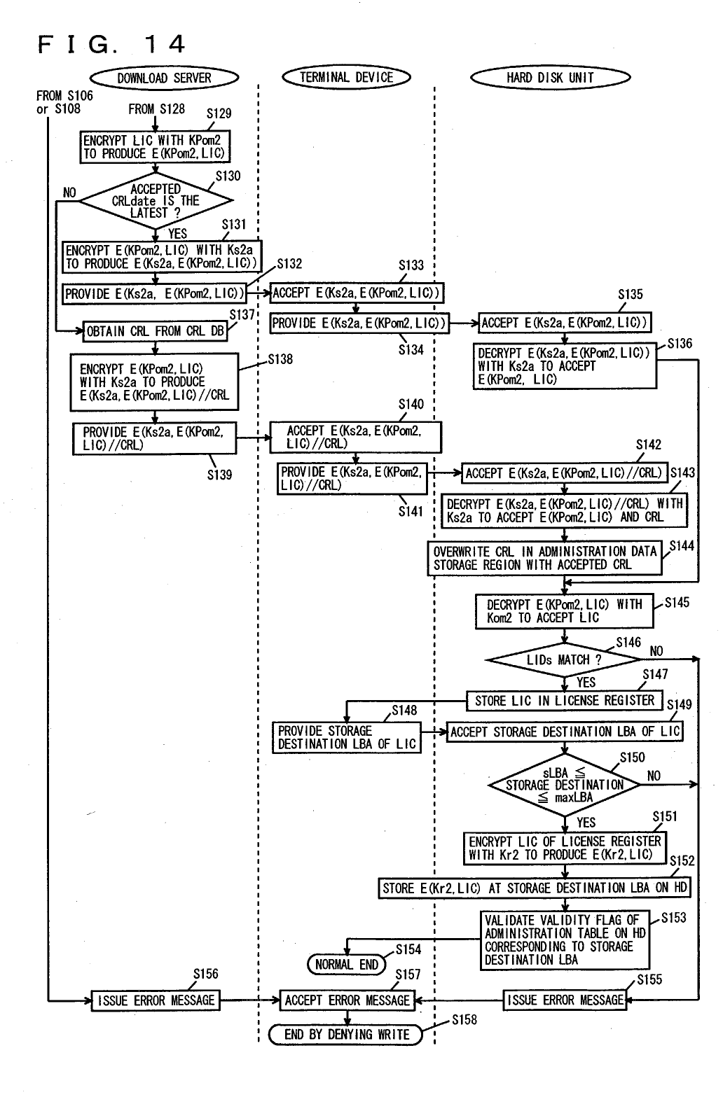

The protection data write processing (step S30) illustrated in FIG. 11 will now be described in greater detail. The protection data write processing is the “write” of the license as already described. Therefore, description will be given on the distribution processing of distributing the license from download server 10 to terminal device 20 provided with hard disk unit 40 shown in FIG. 1. FIGS. 13 and 14 are first and second flow charts illustrating an operation of distributing the license from download server 10 shown in FIG. 1, respectively. The processing of writing the protection data (step S30) is performed between hard disk unit 40 and terminal device 20.

Before the processing in FIG. 13, the user connects terminal device 20 to download server 10 over the telephone network, obtains data ID for the intended content to be downloaded, and issues a distribution request to download server 10. Also, the state of recording in protection data storage region 2120 of hard disk unit 40 is already ascertained, the free space of protection data storage region 2120 is determined, and thereby logical address LBA for recording the new license is determined before the processing in FIG. 13. Further, the input/output of data as well as the provision of instructions to or from hard disk unit 40 are made with extended ATA commands in accordance with this flow chart.

Referring to FIG. 13, the user of terminal device 20 instructs via console panel 1108 the processing of receiving the license.

When the license receiving processing is instructed, controller 1106 issues an output request for a certificate to hard disk unit 40 via bus BS2 and hard disk interface 1200 (step S100). Controller 1420 of hard disk unit 40 accepts the output request for the certificate via terminal 1439, ATA-interface 1438 and bus BS3 (step S101). Controller 1420 reads certificate Cm1 from certificate holding unit 1400 via bus BS3, and outputs certificate Cm1 via bus BS3, ATA-interface 1438 and terminal 1439 (step S102).

Controller 1106 of terminal device 20 accepts certificate Cm1 from hard disk unit 40 via hard disk interface 1200 and bus BS2 (step S103), and sends certificate Cm1 thus accepted to download server 10 (step S104). Download server 10 accepts certificate Cm1 sent from terminal device 20 (step S105). Decryption processing unit 312 decrypts signature data E(Ka, H(KPcm1//lcm1)) of certificate Cm1=KPcm1//lcm1//E(Ka, H(KPcm1//lcm1)) provided from hard disk unit 40 with authentication key KPa provided from authentication key holding unit 313, and provides the data thus decrypted, i.e., Hash value H(KPcm1//lcm1) to distribution control unit 315. Distribution control unit 315 calculates the Hash value with respect to KPcm1//lcm1 of certificate Cm1, and determines whether the calculated Hash value matches with Hash value H(KPcm1//lcm1) received from decryption processing unit 312. Thus, download server 10 verifies certificate Cm1 by confirming that decryption processing unit 312 can decrypt signature data E(Ka, H(KPcm1//lcm1)) of certificate Cm1 with authentication key KPa, and that the Hash value received by distribution control unit 315 from hard disk unit 40 on the sender matches with the Hash value calculated by distribution control unit 315 itself (step S106).

Distribution control unit 315 performs authentication processing by determining from the result of decryption by decryption processing unit 312 whether the certificate encrypted for certifying its validity by a regular authority is received or not. When it is determined that the valid certificate is received, distribution control unit 315 performs next processing (step S107). If the certificate is not valid, the authentication is not performed, and an error message is issued to terminal device 20 (step S156) so that terminal device 20 accepts the error message (step S157). Thereby, the writing is denied, and the distribution operation ends (step S158).

When it is determined from the result of authentication that the access is made from the terminal device provided with the hard disk unit having the valid certificate, distribution control unit 315 in download server 10 obtains certificate revocation list CRL from CRL database 306 (step S107), and determines whether certificate Cm1 is included in certificate revocation list CRL or not (step S108). More specifically, distribution control unit 315 determines whether the certificate number of certificate Cm1 is included in certificate revocation list CRL or not. When certificate Cm1 is included in certificate revocation list CRL, an error message is issued to the terminal device so that the writing is denied, and the distribution operation ends as already described (steps S156-S158).

When it is determined in step S108 that certificate Cm1 is not included in certificate revocation list CRL, distribution control unit 315 accepts class public encryption key KPcm1 from hard disk unit 40 (step S109), and produces a license ID for identifying the license, of which distribution is requested (step S110).

Thereafter, distribution control unit 315 produces control information AC (step S111), and session key generating unit 316 produces a session key Ks1a for distribution (step S112). Session key Ks1a is encrypted by encryption processing unit 318 with class public encryption key KPcm1, which is obtained by decryption processing unit 312 and corresponds to hard disk unit 40 (step S13).

Distribution control unit 315 sends, as license ID//E(KPcm1, Ks1a), the license ID and encrypted session key Ks1a to terminal device 20 via bus BS1 and communication device 350 (step S114).

When terminal device 20 receives license ID//E(KPcm1, Ks1a) (step S115), controller 1106 provides license ID//E(KPcm1, Ks1a) to hard disk unit 40 via bus BS2 and hard disk interface 1200 (step S116), and controller 1420 of hard disk unit 40 accepts license ID//E(KPcm1, Ks1a) via terminal 1439, ATA-interface 1438 and bus BS3 (step S117). Controller 1420 provides encrypted data E(KPcm1, Ks1a) to decryption processing unit 1422 via bus BS3, and decryption processing unit 1422 decrypts it with class private decryption key Kcm1, which is held by Kcm holding unit 1421 and is unique to hard disk unit 40. Thereby, session key Ks1a is decrypted and accepted (step S118).

Thereby, distribution control unit 315 of download server 10 sends the output request for the session key to terminal device 20 via bus BS1 and communication device 350, and controller 1106 of terminal device 20 receives the output request for the session key, and sends it to hard disk unit 40 via hard disk interface 1200 (step S119). Controller 1420 of hard disk unit 40 accepts the output request for the session key via terminal 1439, ATA-interface 1438 and bus BS3, and controls session key generating unit 1418 to generate the session key. Session key generating unit 1418 produces session key Ks2a (step S120), and controller 1420 controls storage/read processing unit 1424 and seek control unit 1425 to read the update date and time of the certificate revocation list from certificate revocation list CRL stored in administration data storage region 2210 of hard disks 1430 and 1431. Storage/read processing unit 1424 reads update date/time CRLdate from administration data storage region 2210 via heads 1435-1437 fixed to the ends of respective arms 1433A-1433C, and provides update date/time CRLdate onto bus BS3. Controller 1420 obtains update date/time CRLdate on bus BS3 (step S121).

Controller 1420 provides update date/time CRLdate thus obtained to encryption processing unit 1406 via bus BS3, and encryption processing unit 1406 encrypts, as one data string, session key Ks2a provided from session key generating unit 1418, unique public encryption key KPom2 provided from KPom holding unit 1416 and update date/time CRLdate provided from controller 1420 with session key Ks1a provided from decryption processing unit 1422, and encrypted data E(Ks1a, Ks2a//KPom2//CRLdate) thus produced is provided onto bus BS3 (step S122). Controller 1420 provides data LID//E(Ks1a, Ks2a//KPom2//CRLdate), which is prepared by adding license ID (LID) to encrypted data E(Ks1a, Ks2a//KPom2//CRLdate) provided onto bus BS3, to terminal device 20 via bus BS3, ATA-interface 1438 and terminal 1439 (step S123). Terminal device 20 accepts data LID//E(Ks1a, Ks2a//KPom2//CRLdate)(step S124), and sends data LID//E(Ks1a, Ks2a//KPom2//CRLdate) thus accepted to download server 10 (step S125).

Download server 10 receives data LID//E(Ks1a, Ks2a//KPom2//CRLdate)(step S126), and decryption processing unit 320 decrypts encrypted data E(Ks1a, Ks2a//KPom2//CRLdate) with session key Ks1a, and accepts session key Ks2a produced by hard disk unit 40, unique public encryption key KPom2 of hard disk unit 40 and update date/time CRLdate of the certificate revocation list held in hard disk unit 40 (step S127).

Distribution control unit 315 obtains data ID (DID) and content key Kc from information database 304, and produces license LIC (step S128).

Referring to FIG. 14, distribution control unit 315 provides license LIC thus produced, i.e., license ID, data ID, content key Kc and control information AC to encryption processing unit 326. Encryption processing unit 326 encrypts license LIC with unique public encryption key KPom2 of hard disk unit 40 obtained by decryption processing unit 320, and produces encrypted data E(KPom2, LIC) (step S129).

Thereby, distribution control unit 315 refers to CRL database 306, and determines whether update date/time CRLdate accepted from hard disk unit 40 is the latest or not (step S130). When it is determined that accepted update date/time CRLdate is the latest, the operation moves to a step S131. When it is determined that accepted update date/time CRLdate is not the latest, the operation moves to a step S137.

When it is determined in step S130 that accepted update date/time CRLdate is the latest, encryption processing unit 328 further encrypts encrypted data E(KPom2, LIC) provided from encryption processing unit 326 with session key Ks2a decrypted by decryption processing unit 320, and thereby produces encrypted data E(Ks2a, (KPom2, LIC)) (step S131). Distribution control unit 315 provides encrypted data E(Ks2a, (KPom2, LIC)) to terminal device 20 via bus BS1 and communication device 350 (step S132), and terminal device 20 accepts encrypted data E(Ks2a, (KPom2, LIC)) (step S133).

Controller 1106 of terminal device 20 provides encrypted data E(Ks2a, (KPom2, LIC)) to hard disk unit 40 via bus BS2 and hard disk interface 1200 (step S134), and controller 1420 of hard disk unit 40 accepts encrypted data E(Ks2a, (KPom2, LIC)) via terminal 1439, ATA-interface 1438 and bus BS3 (step S135). Controller 1420 provides accepted encrypted data E(Ks2a, (KPom2, LIC)) to decryption processing unit 1412 via bus BS3, and decryption processing unit 1412 decrypts encrypted data E(Ks2a, (KPom2, LIC)) with session key Ks2a generated by session key generating unit 1418 to accept encrypted data E(KPom2, LIC) (step S136). Thereafter, the operation moves to a step S145.

Conversely, when update date/time CRLdate accepted from hard disk unit 40 is not the latest in step S130, distribution control unit 315 obtains the latest certificate revocation list CRL from CRL database 306 (step S137), and provides the latest certificate revocation list CRL thus obtained to encryption processing unit 328. Encryption processing unit 328 encrypts, as one data string, encrypted data E(KPom2, LIC) provided from encryption processing unit 326 and the latest certificate revocation list CRL provided from distribution control unit 315 with session key Ks2a decrypted by decryption processing unit 320, and produces encrypted data E(Ks2a, E(KPom2, LIC)//CRL) (step S138). Thereby, distribution control unit 315 provides encrypted data E(Ks2a, E(KPom2, LIC)//CRL) to terminal device 20 via bus BS1 and communication device 350 (step S139), and terminal device 20 accepts encrypted data E(Ks2a, E(KPom2, LIC)//CRL) (step S140).

Controller 1106 of terminal device 20 provides encrypted data E(Ks2a, E(KPom2, LIC)//CRL) to hard disk unit 40 via bus BS3 and hard disk interface 1200 (step S141), and controller 1420 of hard disk unit 40 accepts encrypted data E(Ks2a, E(KPom2, LIC)//CRL) via terminal 1439, ATA-interface 1438 and bus BS3 (step S142). Controller 1420 provides encrypted data E(Ks2a, E(KPom2, LIC)//CRL) thus accepted to decryption processing unit 1412 via bus BS3, and decryption processing unit 1412 decrypts encrypted data E(Ks2a, E(KPom2, LIC)//CRL) with session key Ks2a generated by session key generating unit 1418, and thereby accepts encrypted data E(KPom2, LIC) and the accepted latest certificate revocation list CRL (step S143). Thereby, controller 1420 controls storage/read processing unit 1424 and seek control unit 1425 to rewrite the certificate revocation list stored in administration data storage region 2210 of hard disks 1430 and 1431 so that certificate revocation list CRL stored in administration data storage region 2210 is replaced with the accepted latest list (step S144). In this manner, certificate revocation list CRL stored in administration data storage region 2210 is updated and changed into the latest certificate revocation list CRL held in download server 10 upon every distribution processing.

Steps S131-S136 described above are executed when certificate revocation list CRL held in hard disk unit 40 is the same as the latest certificate revocation list CRL held in download server 10. The steps S137-S144 are executed when certificate revocation list CRL held in hard disk unit 40 is older than the latest certificate revocation list CRL held in download server 10.

After step S136 or S144, decryption processing unit 1404 decrypts encrypted data E(KPom2, LIC) provided from decryption processing unit 1412 with unique private decryption key Kom2 provided from Kom holding unit 1402, and accepts license LIC (step S1415). Controller 1420 determines whether license ID (LID) included in license LIC provided from decryption processing unit 1404 matches with license ID (LID) accepted in step S117 or not (step S146). When these do not match with each other, an error message is issued (step S155), and terminal device 20 accepts the error message (step S157) so that the writing is denied and the processing ends (step S158).

When it is determined in step S 146 that two license IDs (LID) match with each other, controller 1420 stores license LIC decrypted by decryption processing unit 1404 in license register 1423 (step S147).

Thereby, terminal device 20 outputs storage destination LBA of the license (step S148), and controller 1420 of hard disk unit 40 accepts storage destination LBA of the license via terminal 1439, ATA-interface 1438 and bus BS3 (step S149). Controller 1420 determines whether accepted storage destination LBA falls within the range of logical addresses from (sLBA+1) to maxLBA assigned to protection data storage region 2120 of hard disks 1430 and 1431 (step S150). When accepted storage destination LBA exceeds the range of logical addresses from (sLBA+1) to maxLBA, an error message is issued to hard disk interface 1200 via bus BS3, ATA-interface 1438 and terminal 1439 (step S155), and controller 1106 of terminal device 20 accepts the error message via hard disk interface 1200 and bus BS2 (step S157) so that the writing is denied, and the distribution operation ends (step S158).

When it is determined in step S150 that accepted storage destination LBA falls within the range of logical addresses from (sLBA+1) to maxLBA, controller 1420 reads license LIC from license register 1423 via bus BS3, and provides license LIC thus read to encryption processing unit 1427. Encryption processing unit 1427 produces encrypted data E(Kr2, LIC) by encrypting license LIC with unique record key Kr2 provided from Kr holding unit 1429 (step S151).

Thereby, controller 1420 instructs seek control unit 1425 to move heads 1435-1437 for recording the license in storage destination LBA thus accepted, and instructs storage/read processing unit 1424 to record encrypted data E(Kr2, LIC) in the storage block corresponding to the storage destination LBA on hard disks 1430 and 1431. Storage/read processing unit 1424 stores encrypted data E(Kr2, LIC) at storage destination LBA in protection data storage region 2120 via heads 1435 1437 fixed to the ends of arms 1433A-1433C (step S152). Thereafter, controller 1420 changes the validity flag in administration table 170 corresponding to the storage destination LBA, which is stored in administration data storage region 2210 of hard disks 1430 and 1431, to the valid state (step S153). More specifically, controller 1420 reads one storage block including the validity flag corresponding to the storage destination LBA in administration table 170, which is stored in administration data storage region 2210, and overwrites the data in the read storage block with the data, in which the validity flag corresponding to the one storage destination LBA in administration table 170 thus read is changed to the valid state. Thereby, the distribution of license ends normally (step S154).

Although not illustrated in the flow charts of FIGS. 13 and 14, the distribution processing is performed in such manner that controller 1106 of terminal device 20 sends the distribution request for the encrypted content data to download server 10 after the distribution of license ends normally, and download server 10 receives the distribution request for the encrypted content data. Distribution control unit 315 of download server 10 obtains encrypted content data E(Kc, Dc) and additional information Di from information database 304, and sends them to terminal device 20 via bus BS1 and communication device 350.

Terminal device 20 receives data E(Kc, Dc)//Di, and accepts encrypted data E(Kc, Dc) and additional information Di. Thereby, controller 1106 handles encrypted content data E(Kc, Dc) and additional information Di as one content file, and provides it for storage in normal data storage region 2110 of hard disk unit 40 via bus BS2 and hard disk interface 1200. Controller 1106 produces the license administration file, which includes storage destination LBA designated in step S148 as well as plaintext of license ID and data ID (DID), and corresponds to the content file already received. Controller 1106 provides the license administration file thus produced via bus BS2 and hard disk interface 1200 to normal data storage region 2110 of hard disk unit 40 for storage.

Further, controller 1106 of terminal device 20 reads content list file 160 stored in normal data storage region 2110 of hard disk unit 40, adds the names of the accepted content file and the license administration file as well as the information (names of tunes and artists) relating to the encrypted content data and extracted from additional information Di to a content list file 160 thus read, and provides the file thus prepared to normal data storage region 2110 of hard disk unit 40 via bus BS2 and hard disk interface 1200 for rewriting content list file 160 stored therein. When the distribution processing ends.

The writing of the content file and license administration file as well as reading/writing of content list file 160 are performed by the normal data write processing (step S60) illustrated in FIG. 11 or the normal data read processing (step S70), and therefore, detailed description thereof is not repeated.

However, when logical address LBA in protection data storage region 2120 is erroneously instructed in the normal data write processing and normal data read operation, the processing is denied by hard disk unit 40, and access cannot be made.

In steps S151 and S152, after license LIC is recorded in protection data storage region 2120 on hard disks 1430 and 1431 after encrypting it with unique record key Kr2 uniquely assigned to hard disk unit 40. This is performed for the following reason. Generally, the hard disk does not have high security, and there is a possibility that a license may be output from hard disk unit 40 in response to invalid access. In this case, if the license in the plaintext form were stored in protection data storage region 2120, the license would be duplicated in response to invalid access. By encrypting the license with the unique record key (private key) uniquely assigned to hard disk unit 40, unique record key Kr2 cannot be obtained in the destination even when encrypted data E(Kr2, LIC) is provided to the destination from hard disk unit 40 in response to invalid access. Therefore, encrypted data E(Kr2, LIC) cannot be decrypted so that copy of the license can be prevented.

In this manner, the license can be distributed after it is determined that hard disk unit 40, which is attached to terminal device 20 for storing the license, holds the regular certificate, and at the same time, certificate Cm1 including public encryption key KPcm1 is valid. Therefore, it is possible to inhibit distribution of the license to invalid hard disk unit.

The download server and the hard disk unit produce the encryption keys, respectively, and exchange them with each other. Each of the download server and the hard disk unit encrypts the data with the accepted encryption key, and sends the encrypted data to the other. Thereby, mutual authentication can be practically performed in the sending and receiving of the encrypted data so that the security in the distribution system can be improved.

[Shift/Copy between Hard Disk Units]

The processing of moving or duplicating the protection data illustrated in FIG. 11 (step S40) will be described later in greater detail. The processing of moving or duplicating the protection data is the “transfer” of the license as already described when it is performed in hard disk unit 40. Therefore, description will now be given on the processing of moving/duplicating the license from hard disk unit 40 to hard disk unit 41 in terminal device 20 provided with hard disk units 40 and 41 shown in FIG. 3. Procedures between terminal device 20 and hard disk unit 40 correspond to the processing of moving/duplicating the protection data (step S40), and the procedures performed between terminal device 20 and hard disk unit 41 correspond to the protection data write processing (step S30).

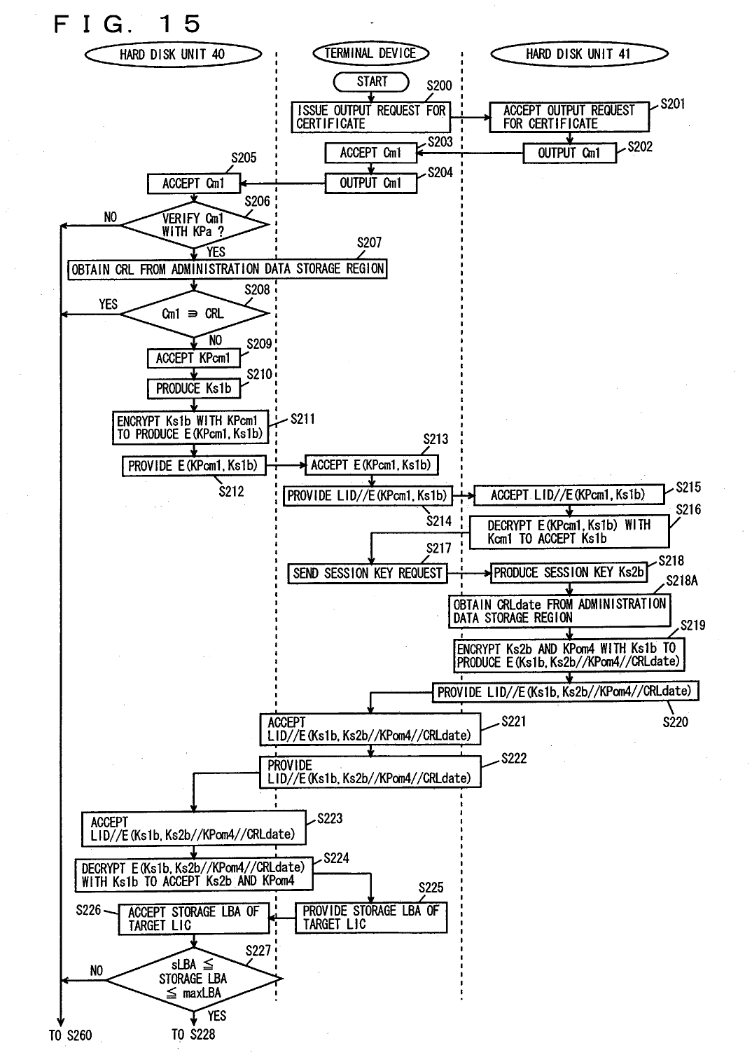

FIGS. 15-17 are first to third flow charts for illustrating the processing of moving or duplicating the license, which is stored in hard disk unit 40 shown in FIG. 3, to hard disk unit 41 via terminal device 20, respectively. Before the processing in FIG. 15, controller 1106 of terminal device 20 is connected to an input unit (not shown) to be used by the user for designating the content corresponding to the license to be moved or duplicated, and for requesting the shift or copy of the license, and receives the user's designation of the content corresponding to the license to be moved or duplicated, and the user's request for shift or copy of the license. Controller 1106 refers to the content list file in hard disk unit 40 on the sender side, and specifies the license administration file of the license to be moved or duplicated. Then, controller 1106 refers to the specified license administration file, and obtains the logical address LBA of protection data storage region 2120 in hard disk unit 40 storing the license to be moved or duplicated. Further, before the processing in FIG. 15, controller 1106 determines the free space in protection data storage region 2120 of hard disk unit 41 on the receiver side, and determines logical address LBA for storing the moved or duplicated address. Whether the license is to be transferred or duplicated depends on control information AC included in the license, and therefore, “shift/copy” is used in the flow charts.

Referring to FIG. 15, when the shift/copy request is made by the user, controller 1106 sends the output request for the certificate to hard disk unit 41 via bus BS (step S200). Controller 1420 of hard disk unit 41 receives the output request for the certificate via terminal 1439, ATA-interface 1438 and bus BS3 (step S201).

When controller 1420 of hard disk unit 41 receives the output request for the certificate, it reads certificate Cm1 from certificate holding unit 1400 via bus BS3, and provides read certificate Cm1 to controller 1106 of terminal device 20 via bus BS3, ATA-interface 1438 and terminal 1439 (step S202). Controller 1106 of terminal device 20 accepts certificate Cm1 of hard disk unit 41 via bus BS (step S203), and sends certificate Cm1 of hard disk unit 41 to hard disk unit 40 via bus BS (step S204).

Thereby, processing starts in hard disk unit 40. Controller 1420 receives certificate Cm1 via terminal 1439, ATA-interface 1438 and bus BS3 (step S205), and provides received certificate Cm1 to authentication processing unit 1408 via bus BS3. Authentication processing unit 1408 executes the decryption processing on certificate Cm1 with authentication key KPa provided from KPa holding unit 1414, and provides the result of decryption to controller 1420. Controller 1420 calculates the Hash value for data KPcm1//lcm1 of certificate Cm1, and determines whether the calculated Hash value matches with Hash value H(KPcm1//lcm1) received from authentication processing unit 1408 or not. Thus, hard disk unit 40 verifies certificate Cm1 by confirming that authentication processing unit 1408 can decrypt encrypted data E(Ka, H(KPcm1//lcm1)) of certificate Cm1 with authentication key KPa or not, and that the Hash value received by controller 1420 from hard disk unit 41 of the sender matches with the Hash value calculated by controller 1420 (step S206).

When it is determined that the certificate is valid, controller 1420 starts next processing (step S207). When the certificate is not valid, the authentication is not performed, and an error message is issued to terminal device 20 (step S260). Terminal device 20 accepts the error message (step S262), and the output of license LIC is denied so that the shift/copy processing ends (step S263).

When it is determined from the result of authentication that the transfer is performed to the hard disk unit having the valid certificate, controller 1420 in hard disk unit 40 controls storage/read processing unit 1424 and seek control unit 1425 to read certificate revocation list CRL from administration data storage region 2210 on hard disks 1430 and 1431. Storage/read processing unit 1424 reads certificate revocation list CRL from administration data storage region 2210 via heads 1435-1437 fixed to the ends of respective arms 1433A-1433C, and provides certificate revocation list CRL thus read onto bus BS3. Controller 1420 obtains certificate revocation list CRL via bus BS3 (step S207), and determines whether certificate Cm1 of hard disk unit 41 is included in certificate revocation list CRL or not (step S208). More specifically, controller 1420 determines whether the certificate number of certificate Cm1 of hard disk unit 41 is included in certificate revocation list CRL or not. When certificate Cm1 of hard disk unit 41 is included in certificate revocation list CRL, an error message is issued to terminal device 20, and the output of license LIC is denied so that the shift/copy processing ends (steps S260, S262 and S263).

When it is determined in step S208 that the certificate number of certificate Cm1 of hard disk unit 41 is not included in certificate revocation list CRL, controller 1420 accepts class public encryption key KPcm1 from hard disk unit 40 (step S209), and controls session key generating unit 1418 to produce session key Ks1b so that session key generating unit 1418 produces session key Ks1b (step S210).

Thereafter, session key Ks1b is encrypted by encryption processing unit 1410 with class public encryption key KPcm1, which is obtained by authentication processing unit 1408 and corresponds to hard disk unit 41 (step S211).

Controller 1420 receives encrypted data E(KPcm1, Ks1b) from encryption processing unit 1410 via bus BS3, and provides encrypted data E(KPcm1, Ks1b) thus received to terminal device 20 via bus BS3, ATA-interface 1438 and terminal 1439 (step S212).

When terminal device 20 receives encrypted data E(KPcm1, Ks1b) (step S213), controller 1106 provides encrypted data E(KPcm1, Ks1b) to hard disk unit 41 via bus BS (step S214), and the processing is then performed in hard disk unit 41. In hard disk unit 41, controller 1420 accepts encrypted data E(KPcm1, Ks1b) via terminal 1439, ATA-interface 1438 and bus BS3 (step S215). Controller 1420 provides encrypted data E(KPcm1, Ks1b) to decryption processing unit 1422 via bus BS3, and decryption processing unit 1422 performs the decryption processing with class private decryption key Kcm1, which is unique to hard disk unit 41 and is held by Kcm holding unit 1421, so that it produces session key Ks1b by decryption, and accepts it (step S216).

Thereby, controller 1420 of terminal device 20 sends an output request for the session key to hard disk unit 41 via bus BS (step S217). Controller 1420 of hard disk unit 41 accepts the output request for the session key via terminal 1439, ATA-interface 1438 and bus BS3, and controls session key generating unit 1418 to generate the session key. Session key generating unit 1418 produces session key Ks2b (step S218), and controller 1420 controls storage/read processing unit 1424 and seek control unit 1425 to read the update date and time of certificate revocation list CRL from certificate revocation list CRL stored in administration data storage region 2210 of hard disks 1430 and 1431. Storage/read processing unit 1424 reads update date/time CRLdate from administration data storage region 2210 via heads 1435-1437 fixed to the ends of respective arms 1433A-1433C, and provides update date/time CRLdate to bus BS3. Controller 1420 obtains update date/time CRLdate on bus BS3 (step S218A). Controller 1420 provides obtained update date/time CRLdate to encryption processing unit 1406. Encryption processing unit 1406 encrypts, as one data string, session key Ks2b, unique public encryption key KPom4 and update date/time CRLdate, which are provided from decryption processing unit 1422, session key generating unit 1418, KPom holding unit 1416 and controller 1420, respectively, with session key Ks1b provided from decryption processing unit 1422, and thereby provides encrypted data E(Ks1b, Ks2b//KPom4//CRLdate) onto bus BS3 (step S219). Controller 1420 adds license ID (LID) to encrypted data E(Ks1b, Ks2b//KPom4//CRLdate) on bus BS3 to provide data LID//E(Ks1b, Ks2b//KPom4//CRLdate) to terminal device 20 via bus BS3, ATA-interface 1438 and terminal 1439 (step S220). Terminal device 20 accepts data LID//E(Ks1b, Ks2b//KPom4//CRLdate) via bus BS (step S221), and provides accepted data LID//E(Ks1b, Ks2b//KPom4//CRLdate) to hard disk unit 40 (step S222). Then, processing is performed in hard disk unit 40 again.

Hard disk unit 40 accepts data LID//E(Ks1b, Ks2b//KPom4//CRLdate) in a step S223, and decryption processing unit 1412 decrypts encrypted data E(Ks1b, Ks2b//KPom4//CRLdate) with session key Ks1b to accept session key Ks2b produced by hard disk unit 41 and unique public encryption key KPom4 of hard disk unit 41 (step S224).

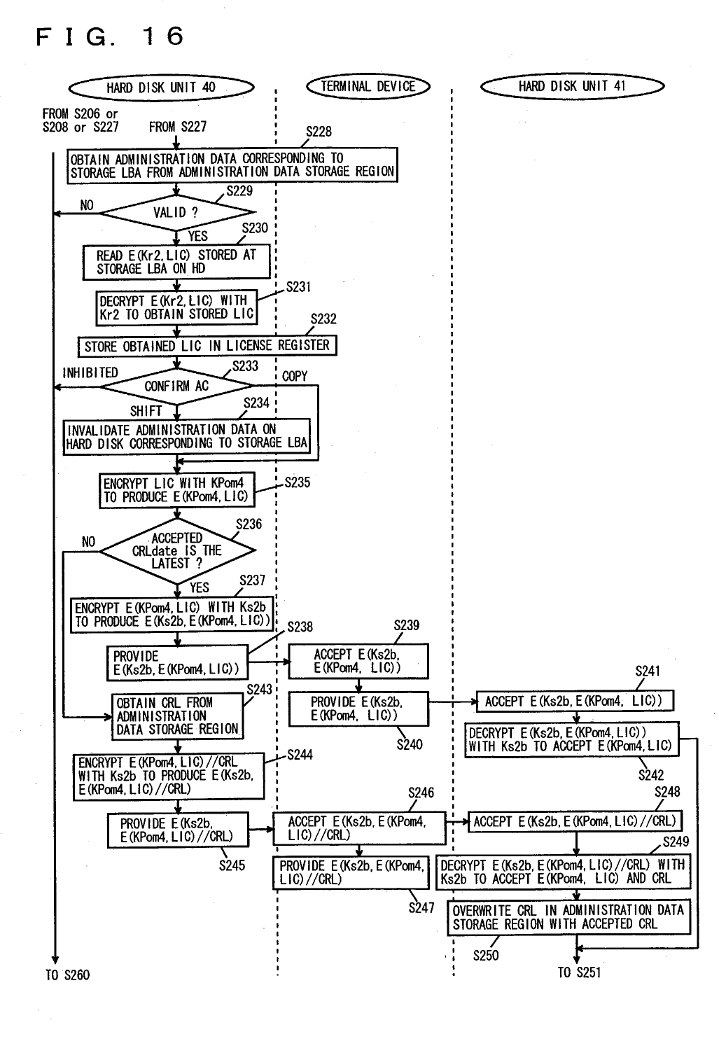

Thereby, controller 1106 of terminal device 20 extracts storage LBA, which is the stored logical address of license LIC to be moved or duplicated, from the license administration file, which has been obtained in advance, and provides the extracted storage LBA (step S225). Storage LBA is the logical address stored in license LIC. Controller 1420 of hard disk unit 40 accepts storage LBA via terminal 1439, ATA-interface 1438 and bus BS3 (step S226). Controller 1420 determines whether the accepted storage LBA falls within the range of logical addresses from (sLBA+1) to maxLBA assigned to protection data storage region 2120 (step S227). When storage LBA exceeds the range of logical addresses from (sLBA+1) to maxLBA, an error message is issues to terminal device 20 via bus BS3, ATA-interface 1438 and terminal 1439, and the output of license LIC is denied so that shift/copy ends (steps S260, S262 and S263). When it is determined in step S227 that storage destination LBA falls within the range of logical addresses from (sLBA+1) to maxLBA, the operation moves to a step S228 in FIG. 16.

Referring to FIG. 16, controller 1420 of hard disk unit 40 reads a validity flag for storage LBA in administration table 170. More specifically, controller 1420 instructs seek control unit 1425 and storage/read processing unit 1424 to read one storage block including the validity flag, which corresponds to storage LBA in administration table 170 stored in administration data storage region 2210. Storage/read processing unit 1424 reads a portion of administration table 170 stored in administration data storage region 2210 from administration data storage region 2210 on hard disks 1430 and 1431, and provides it onto bus BS3. Controller 1420 obtains the portion of administration table 170 from bus BS3. Controller 1420 extracts and obtains the validity flag corresponding to storage LBA from the portion of the administration table thus obtained (step S228). Thereby, controller 1420 determines whether the obtained validity flag corresponding to storage LBA is valid or not (step S229). When it is determined that the validity flag is not valid, controller 1420 issues an error message as already described, and the output of license LIC is denied so that the shift/copy processing ends (steps S260, S262 and S263).

When it is determined in step S229 that the validity flag corresponding to storage LBA is valid, controller 1420 instructs seek control unit 1425 to moves heads 1435-1437 for reading the license stored at accepted storage LBA, and instructs storage/read processing unit 1424 to read encrypted data E(Kr2, LIC), which is recorded in the storage block of protection data storage region 2120 on hard disks 1430 and 1431 corresponding to storage LBA. Storage/read processing unit 1424 reads encrypted data E(Kr2, LIC), which is recorded in the region designated by storage LBA, from protection data storage region 2120 via heads 1435-1437 (step S230), and provides encrypted data E(Kr2, LIC) thus read onto bus BS3. Thereby, controller 1420 provides encrypted data E(Kr2, LIC) on bus BS3 to decryption processing unit 1428. Decryption processing unit 1428 decrypts encrypted data E(Kr2, LIC) with unique record key Kr2 provided from Kr holding unit 1429, and provides license LIC onto bus BS3 (step S231). Controller 1420 stores license LIC on bus BS3 in license register 1423 (step S232), and determines based on control information AC included in the stored license LIC whether the shift/copy of the license to hard disk unit 41 is inhibited or not (step S233). When the shift/copy is inhibited, the writing is denied through steps S260 and S262, and the operation for the shift/copy ends (step S263). When the copy of the license is allowed, the operation moves to a step S235. When the shift of the license is allowed, controller 1420 invalidates the validity flag in administration table 170 corresponding to the storage LBA (step S234). More specifically, controller 1420 produces the data by validating the validity flag corresponding to storage destination LBA in a portion of administration table 170 read in step S228, and controls seek control unit 1425 to move heads 1435-1437 to record.the data thus produced at the position of the read storage block in administration data storage region 2210 by overwriting.

When it is determined in step S233 that the copy is allowed, or after step S234, controller 1420 reads the license stored in license register 1423, and provides it to encryption processing unit 1417. Encryption processing unit 1417 encrypts license LIC with unique public encryption key KPom4 of hard disk unit 41 to provide encrypted data E(KPom4, LIC) (step S235).

Thereby, controller 1420 compares update date/time CRLdate accepted from hard disk unit 41 with the update date and time of certificate revocation list CRL, which are read from administration data storage region 2210 in step S207 and are administered in hard disk unit 40, to determine whether certificate revocation list CRL of hard disk unit 41 is the latest or not (step S236). When it is determined that certificate revocation list CRL of hard disk unit 41 is the latest, the operation moves to a step S237. When it is determined that accepted update date/time CRLdate is not the latest, the operation moves to a step S243.

When it is determined in step S236 that certificate revocation list CRL of hard disk unit 41 is not the latest, encryption processing unit 1406 further encrypts encrypted data E(KPom4, LIC) provided from encryption processing unit 1417 with session key Ks2b decrypted by decryption processing unit 1412 to produce encrypted data E(Ks2b, E(KPom4, LIC)) (step S237). Controller 1420 provides encrypted data E(Ks2b, E(KPom4, LIC)) to terminal device 20 via bus BS3, ATA-interface 1438 and terminal 1439 (step S238), and terminal device 20 accepts encrypted data E(Ks2b, E(KPom4, LIC)) (step S239).

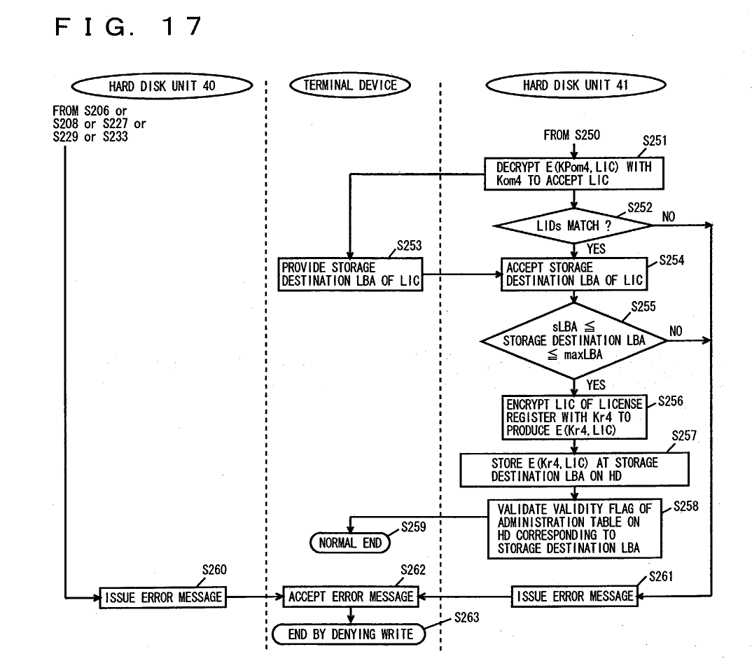

Controller 1106 of terminal device 20 provides encrypted data E(Ks2b, E(KPom4, LIC)) to hard disk unit 41 via bus BS (step S240), and the processing moves to hard disk unit 41. Controller 1420 of hard disk unit 41 accepts encrypted data E(Ks2b, E(KPom4, LIC)) via terminal 1439, ATA-interface 138 and bus BS3 (step S241). Controller 1420 provides accepted encrypted data E(Ks2b, E(KPom4, LIC)) to decryption processing unit 1412 via bus BS3, and decryption processing unit 1412 decrypts encrypted data E(Ks2b, E(KPom4, LIC)) with session key Ks2b generated by session key generating unit 1418, and accepts encrypted data E(KPom4, LIC) (step S242). Thereafter, the operation moves to a step S251 illustrated in FIG. 17.

When it is determined in step S236 that certificate revocation list CRL of hard disk unit 41 is not the latest, hard disk unit 40 operates to provide certificate revocation list CRL, which is read from administration data storage region 2210 in step S207 and is administered in hard disk unit 40, to encryption processing unit 1406 as the latest certificate revocation list. Encryption processing unit 1406 encrypts, as one data string, encrypted data E(KPom4, LIC) provided from encryption processing unit 1417 and the latest certificate revocation list CRL provided from controller 1420 with session key Ks2b decrypted by decryption processing unit 1412, and produces encrypted data E(Ks2b, E(KPom4, LIC)//CRL) (step S244). Thereby, controller 1420 provides encrypted data E(Ks2b, E(KPom4, LIC)//CRL) to terminal device 20 via bus BS3, ATA-interface 1438 and terminal 1439 (step S245), and terminal device 20 accepts encrypted data E(Ks2b, E(KPom4, LIC)//CRL) (step S246).

Controller 1106 of terminal device 20 provides encrypted data E(Ks2b, E(KPom4, LIC)//CRL) to hard disk unit 41 via bus BS (step S247), and the processing moves to hard disk unit 41. Controller 1420 of hard disk unit 41 accepts encrypted data E(Ks2b, E(KPom4, LIC)//CRL) via terminal 1439, ATA-interface 1438 and bus BS3 (step S248). Controller 1420 provides encrypted data E(Ks2b, E(KPom4, LIC)//CRL) thus accepted to decryption processing unit 1412 via bus BS3, and decryption processing unit 1412 decrypts encrypted data E(Ks2b, E(KPom4, LIC)//CRL) with session key Ks2b provided from session key generating unit 1418 to accept encrypted data E(KPom4, LIC) and certificate revocation list CRL (step S249). Thereby, controller 1420 controls seek control unit 1425 and storage/read processing unit 1424 to overwrite the certificate revocation list stored in administration data storage region 2210 of hard disks 1430 and 1431 with accepted certificate revocation list CRL. Storage/read processing unit 1424 overwrites certificate revocation list CRL stored in administration data storage region 2210 with certificate revocation list CRL accepted from controller 1420 (step S250). Thereby, certificate revocation list CRL stored in administration data storage region 2210 is replaced with the latest one.

Steps S237-S242 described above are performed when certificate revocation list CRL held in hard disk unit 41 is newer than certificate revocation list CRL held in hard disk unit 40, and steps S243-S250 are performed for updating certificate revocation list CRL held in hard disk unit 41 when certificate revocation list CRL held in hard disk unit 41 is older than certificate revocation list CRL held in hard disk unit 40.

Referring to FIG. 17, hard disk unit 41 operates as follows after steps S242 and S250. Decryption processing unit 1404 receives encrypted data E(KPom4, LIC) from decryption processing unit 1412, and decrypts encrypted data E(KPom4, LIC) thus received with unique private decryption key Kom4 provided from Kom holding unit 1402 to accept license LIC (step S251). Controller 1420 stores license LIC decrypted by decryption processing unit 1404 in license register 1423, and determines whether the license ID included in license LIC matches with the license ID already accepted or not (step S252). When the two license IDs do not match with each other, controller 1420 issues an error message to terminal device 20 via bus BS3, ATA-interface 1438 and terminal 1439 (step S261). Controller 1106 of terminal device 20 accepts the error message (step S262), and the writing is denied so that the shift/copy processing ends (step S263).

When the two license IDs match with each other in step S252, controller 1106 of terminal device 20 provides storage destination LBA of license LIC to hard disk unit 41 via bus BS (step S253), and controller 1420 of hard disk unit 41 accepts storage destination LBA of license LIC via terminal 1439, ATA-interface 1438 and bus BS3 (step S254). Controller 1420 determines whether accepted storage destination LBA falls within the range of logical addresses from (sLBA+1) to maxLBA, which are assigned to protection data storage region 2120, or not (step S255). When storage destination LBA exceeds the range of logical addresses from (sLBA+1) to maxLBA, the output of license is denied, and the shift/copy processing ends (steps S261-S263).

When it is determined in step S255 that storage destination LBA falls within the range of logical addresses from (sLBA+1) to maxLBA, controller 1420 reads license LIC stored in license register 1423, and provides it to encryption processing unit 1427. Encryption processing unit 1427 encrypts license LIC with unique record key Kr4 provided from Kr holding unit 1429 to produce encrypted data E(Kr4, LIC)(S256).

Thereby, controller 1420 instructs seek control unit 1425 to move heads 1435-1437 for recording the license in the accepted storage destination LBA, and instructs storage/read processing unit 1424 to record encrypted data E(Kr4, LIC) in the record block corresponding to storage destination LBA on hard disks 1430 and 1431. Storage/read processing unit 1424 stores encrypted data E(Kr4, LIC) in the storage destination LBA of protection data storage region 2120 via heads 1435-1437 fixed to the ends of respective arms 1433A-1433C. Thereafter, controller 1420 validates the validity flag in administration table 170 corresponding to storage destination LBA stored in administration data storage region 2210 of hard disks 1430 and 1431 (step S258). More specifically, controller 1420 reads one storage block including the validity flag corresponding to storage destination LBA in administration table 170 stored in administration data storage region 2210, and writes the data, in which the validity flag corresponding to storage destination LBA of the read portion of administration table 170 is validated, over the read storage block. Thereby, the distribution of the license normally ends (step S259).

In the first to third flow charts shown in FIGS. 15 to 17, processing in steps S205-S212, S223, S224, S226-S228, S243-S245, and S260 is shift/copy processing effected on the protection data in hard disk unit 40, which performs “transfer” of the license. The processing in steps S201, S202, S215, S216, S218-S220, S241, S242, S248-S251, S254-S258, and S261 is the write processing effected on the protection data in hard disk unit 41, which performs “write” of the license.

The values of sLBA and maxLBA in hard disk unit 40 are not necessarily equal to those of sLBA and maxLBA in hard disk unit 41, respectively. In each of hard disk units 40 and 41, maxLBA takes the maximum value of the logical address in user region 2100, and sLBA takes the maximum value of the logical address in normal data storage region 2110.

The shift/copy of encrypted content data E(Kc, Dc) and additional information Di from hard disk unit 40 to hard disk unit 41 is performed independently on the shift/copy of the license, and can be performed by reading the content file, i.e., encrypted content data E(Kc, Dc) and additional information Di, and sending it to hard disk unit 41. The reading of the content file from hard disk unit 40 and the writing of the content file into hard disk unit 41 are performed in the write processing (step S60) of the normal data in FIG. 11 and the read processing (step S70) of the normal data, respectively, and therefore, description thereof is not repeated.

If hard disk unit 41 has already stored the license administration file for the moved or duplicated license, the stored license administration file is obtained, and storage destination LBA provided in step S253 is added thereto. The license administration file thus prepared is provided to hard disk unit 41 again for rewriting the license administration file, which is stored in hard disk unit 41 and corresponds to the moved or duplicated license, and thereby the target license administration file is updated. When the license administration file to be updated is not recorded in hard disk unit 41, a new license administration file is produced, and is recorded in hard disk unit 41 on the receiver side, and content file list 160 stored in normal data storage region 2110 of hard disk unit 41 is obtained. After adding the information relating to the produced data administration file, it is provided to hard disk unit 40 via bus BS2 and hard disk interface 1200 so that content file list 160 stored in normal data storage region 2110 is rewritten.

In connection with hard disk unit 40, the processing is performed as follows. When it is determined in step S233 that the moving processing is allowed, the license administration file, which is stored in normal data storage region 2110 and corresponds to the moved license, is obtained, and storage LBA, which was provided in step S255, is deleted from the license administration file thus obtained. Then, the license administration file is provided to hard disk unit 41 again to update the target license administration file.

In the processing of shift/copy of the license between the hard disk units, as described above, the license can be moved only in response to the request for shift to the regular hard disk unit only after hard disk unit 40 on the sender side determines that hard disk unit 41 on the receiver side is the regular device, and at the same time that class public encryption key KPcm1 is valid. Therefore, it is possible to inhibit the shift to invalid hard disk unit.

Further, the encryption keys produced by the hard disk units are mutually transmitted, and each hard disk unit executes the encryption with the received encryption key, and sends the encrypted data to the other so that the mutual authentication can be practically performed in the operations of transmitting the encrypted data. Thereby, the security in the operations of shift/copy of the license can be improved.

[Usage Permission Processing]

Description will now be given on the details of the usage permission processing (step S50) of the protection data illustrated in FIG. 11. The usage permission processing for the protection data is the “usage permission” of the license as already described. Therefore, in the structure of terminal device 20, which is provided with reproducing circuit 1550 shown in FIG. 2 as well as hard disk unit 40 attached thereto, content key Kc included in license LIC stored in protection data storage region 2120 of hard disk unit 40 is read and provided to reproducing circuit 1550 for reproducing encrypted content data E(Kc, Dc) stored in normal data storage region 2110 of hard disk unit 40.

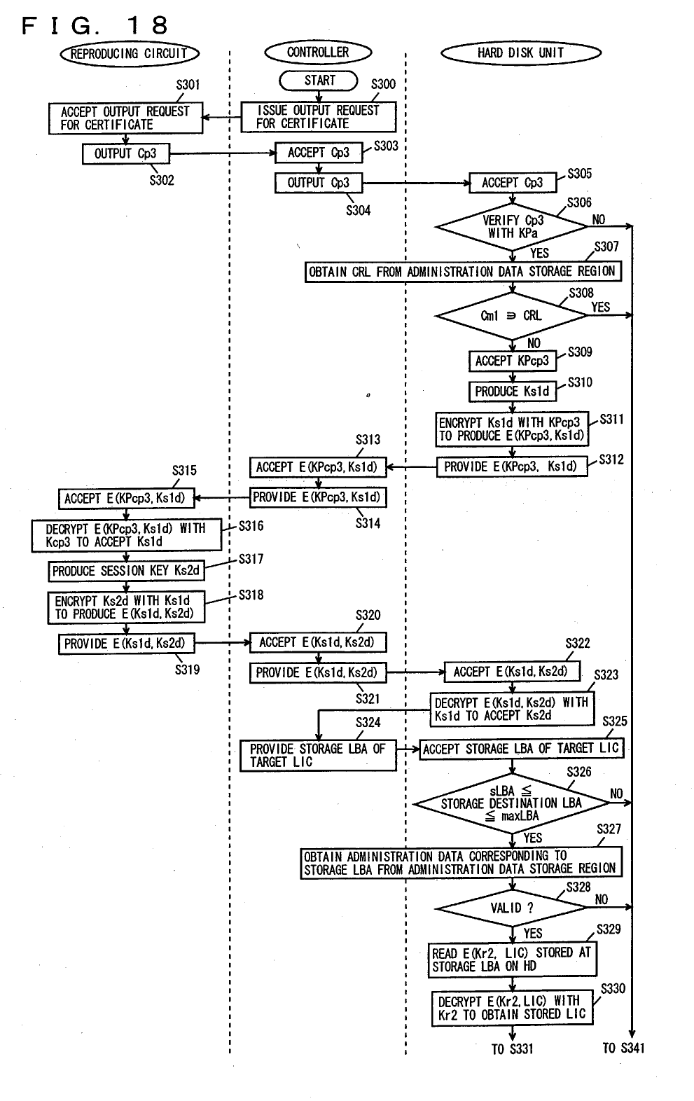

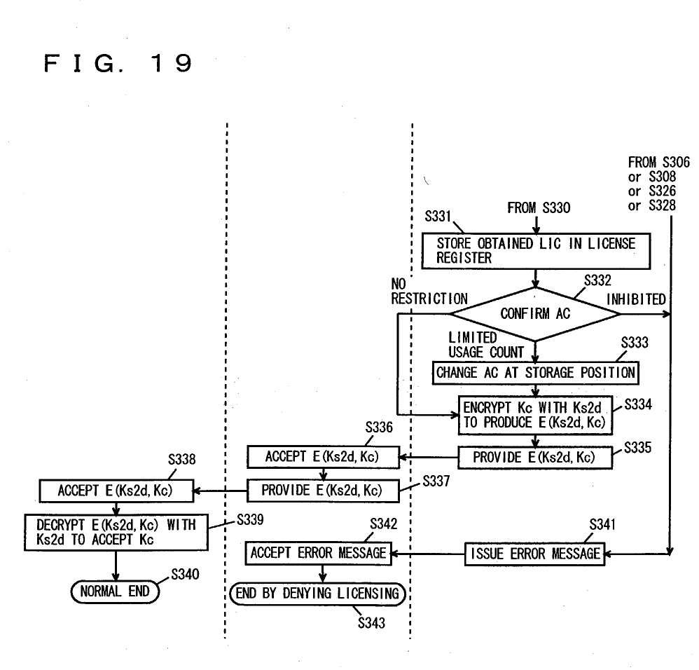

FIGS. 18 and 19 are first and second flow charts for illustrating the usage permission processing for the license used for decrypting the encrypted content data, respectively, and particularly the processing effected by hard disk unit 40 on reproducing circuit 1550 of terminal device 20. When hard disk unit 41 is attached to terminal device 20, the usage permission of the license can likewise be allowed, and can be performed in accordance with the flow charts of FIGS. 18 and 19. Before the processing in FIG. 18, the user of terminal device 20 reads the content list file stored in normal data storage region 2110 of hard disk unit 40, and refers to the content list file thus read to determine the content to be produced from the contents stored in hard disk unit 40. Also, the content file is specified, and the license administration file is read. It is assumed that the above operations are already completed before the following operations.

Referring to FIG. 18, when the usage permission operation starts, the user of terminal device 20 enters the usage permission request into terminal device 20 via console panel 1108. Thereby, controller 1106 provides a request for output of the certificate via bus BS2 (step S300), and reproducing circuit 1550 accepts the certificate output request (step S301). Reproducing circuit 1550 provides certificate Cp3 to controller 1106 (step S302), and controller 1106 accepts certificate Cp3 (step S303), and provides certificate Cp3 to hard disk unit 40 via bus BS (step S304).

Thereby, controller 1420 of hard disk unit 40 accepts certificate Cp3=KPcp3//lcp3//E(Ka, H(KPcp3//lcp3)) via terminal 1439, ATA-interface 1438 and bus BS3 (step S305), and authentication processing unit 1408 decrypts signature data E(Ka, H(KPcp3//lcp3)) of accepted certificate Cp3 with authentication key KPa held by KPa holding unit 1414, and provides Hash value H(KPcp3//lcp3) to controller 1420. Controller 1420 calculates the Hash value corresponding to data KPcp3//lcp3 in certificate Cp3, and determines whether the Hash value thus calculated matches with Hash value H(KPcp3//lcp3) calculated by reproducing circuit 1550 or not. Controller 1420 verifies certificate Cp3 accepted from reproducing circuit 1550 based on the determination that signature data E(Ka, H(KPcp3//lcp3)) is decrypted by authentication processing unit 1408, and that the two Hash values match with each other (step S306). When certificate Cp3 is not authenticated, controller 1420 issues an error message to controller 1106 of terminal device 20 via bus BS3, ATA-interface 1438 and terminal 1439 (step S341), and controller 1106 accepts the error message (step S342). Output of content key Kc is denied so that the usage permission processing ends (step S343).

When the certificate is authenticated, controller 1420 controls seek control unit 1425 and storage/read processing unit 1424 to read certificate revocation list CRL from administration data storage region 2210 of hard disks 1430 and 1431. Storage/read processing unit 1424 reads certificate revocation list CRL from administration data storage region 2210 via heads 1435-1437 fixed to the ends of respective arms 1433A-1433C, and provides certificate revocation list CRL thus read onto bus BS3. Controller 1420 obtains certificate revocation list CRL via bus BS3 (step S307), and determines whether certificate Cm1 is included in the certificate revocation list CRL or not (step S308). More specifically, controller 1420 determines whether the certificate number of certificate Cp3 of reproducing circuit 1550 is included in certificate revocation list CRL or not. When certificate Cp3 of reproducing circuit 1550 is included in certificate revocation list CRL, an error message is issued to terminal device 20 via bus BS3, ATA-interface 1438 and terminal 1439, and the output of content key Kc is denied so that the usage permission operation ends (steps S341-S343).

When it is determined in step S308 that certificate Cp3 of reproducing circuit 1550 is not included in certificate revocation list CRL, controller 1420 accepts class public encryption key KPcp3 from reproducing circuit 1550 (step S309), and controls session key generating unit 1418 to produce session key Ks1d so that session key generating unit 1418 produces session key Ks1d (step S310).

Thereafter, session key Ks1d is encrypted by encryption processing unit 1410 with class public encryption key KPcp3 corresponding to reproducing circuit 1550 obtained by authentication processing unit 1408 (step S311).

Controller 1420 receives encrypted data E(KPcp3, Ks1d) from encryption processing unit 1410 via bus BS3, and sends encrypted data E(KPcp3, Ks1d) thus received to terminal device 20 via bus BS3, ATA-interface 1438 and terminal 1439 (step S312).

When terminal device 20 receives encrypted data E(KPcp3, Ks1d) (step S313), controller 1106 provides encrypted data E(KPcp3, Ks1d) to reproducing circuit 1550 via bus BS2 (step S314), and reproducing circuit 1550 accepts encrypted data E(KPcp3, Ks1d) via bus BS2 (step S315). Encrypted data E(KPcp3, Ks1d) is provided to decryption processing unit 1504, and decryption processing unit 1504 decrypts encrypted data E(KPcp3, Ks1d) with class private decryption key Kcp3 provided from Kcp holding unit 1502, and accepts session key Ks1d produced by hard disk unit 40 (step S316).

Thereby, session key generating unit 1508 produces session key Ks2d for the usage permission (step S317), and provides it to encryption processing unit 1506. Encryption processing unit 1506 encrypts session key Ks2d provided from session key generating unit 1508 with session key Ks1d provided from decryption processing unit 1504 to produce encrypted data E(Ks1d, Ks2d) (step S318), and provides encrypted data E(Ks1d, Ks2d) to controller 1106 (step S319). Controller 1106 accepts encrypted data E(Ks1d, Ks2d) via bus BS2 (step S320), and provides encrypted data E(Ks1d, Ks2d) to hard disk unit 40 via bus BS (step S321).

Thereby, decryption processing unit 1412 of hard disk unit 40 receives encrypted data E(Ks1d, Ks2d) via terminal 1439, ATA-interface 1438 and bus BS3 (step S322). Decryption processing unit 1412 decrypts encrypted data E(Ks1d, Ks2d) with session key Ks1d generated by session key generating unit 1418, and accepts session key Ks2d produced by reproducing circuit 1550 (step S323).

Controller 1106 of terminal device 20 extracts storage LBA of license LIC from the license administration file, which is read in advance and corresponds to the content to be reproduced, and provides storage LBA extracted to hard disk unit 40 via bus BS (step S324). Storage LBA is the logical address, at which license LIC is stored.

Controller 1420 of hard disk unit 40 accepts storage LBA via terminal 1439, ATA-interface 1438 and bus BS3 (step S325), and determines whether accepted storage LBA falls within the range of logical addresses from (sLBA+1) to maxLBA assigned to protection data storage region 2120 (step S326). When storage LBA exceeds the range of logical addresses from (sLBA+1) to maxLBA, the output of content key Kc is denied so that the usage permission processing ends (steps S341-S343).

When it is determined in step S326 that storage LBA falls within the range of logical addresses from (sLBA+1) to maxLBA, controller 1420 of hard disk unit 40 reads the validity flag corresponding to storage LBA in administration table 170. More specifically, controller 1420 instructs seek control unit 1425 and storage/read processing unit 1424 to read one storage block including the validity flag, which is stored in administration data storage region 2210 and corresponds to storage LBA in administration table 170. Storage/read processing unit 1424 reads a portion of administration table 170 stored in administration data storage region 2210 from administration data storage region 2210 on hard disks 1430 and 1431, and provides it onto bus BS3. Thereby, controller 1420 obtains the portion of the administration table from bus BS3, and obtains the validity flag corresponding to storage LBA by extracting it from the obtained portion of the administration table (step S327). Controller 1420 determines whether the validity flag corresponding to obtained storage LBA is valid or not (step S328). When it is determined that the validity flag is not valid, controller 1420 issues an error message as already described, and the output of content key Kc is denied so that the usage permission processing ends (steps S341-S343).

When it is determined in step S328 that the validity flag for storage LBA is valid, controller 1420 instructs seek control unit 1425 to move heads 1435-1437 for reading the license recorded at the accepted storage LBA, and instructs storage/read processing unit 1424 to read encrypted data E(Kr2, LIC) recorded in the storage block of protection data storage region 2120 corresponding to storage LBA on hard disks 1430 and 1431. Storage/read processing unit 1424 reads encrypted data E(Kr2, LIC) stored in the region designated by storage LBA from protection data storage region 2120 via heads 1435-1437 (step S329), and provides encrypted data E(Kr2, LIC) thus read onto bus BS3. Thereby, controller 1420 provides encrypted data E(Kr2, LIC) on bus BS3 to decryption processing unit 1428, and decryption processing unit 1428 decrypts encrypted data E(Kr2, LIC) with unique record key Kr2 provided from Kr holding unit 1429, and provides license LIC onto bus BS3 (step S330).

Referring to FIG. 19, controller 1420 stores license LIC on bus BS3 in license register 1423 (step S331), and determines the conditions of use of license LIC based on control information AC included in stored license LIC (step S332). More specifically, controller 1420 checks the usage count included in control information AC. When the usage count is zero inhibiting reproduction, the output of content key Kc is denied after the processing in steps S341 and S342, and the usage permission processing ends. When the usage count is equal to 255 representing no restriction, the operation moves to a step S344. When the usage count is in a range from 1 to 254, and thus are restricted, controller 1420 decrements the usage count included in control information AC of license LIC stored in license register 1423 by one. Thereby, controller 1420 instructs seek control unit 1425 to move heads 1435-1437 for overwriting the license, which is stored in the storage block designated by storage LBA, with license LIC stored in license register 1423 after changing it into encrypted data E(Kr2, LIC) by encryption processing unit 1427. Also, controller 1420 instructs storage/read processing unit 1424 to record encrypted data E(Kr2, LTC) by overwriting the encrypted data in the storage block corresponding to storage destination LBA on hard disks 1430 and 1431. Storage/read processing unit 1424 changes the encrypted data stored at storage destination LBA into encrypted data E(Kr2, LIC), in which license LIC includes changed control information AC, (step S333). When the usage count is not restricted (equal to 255) in step S332, or after step S333, controller 1420 takes out content key Kc from license LIC stored in license register 1423, and provides content key Kc to encryption processing unit 1406. Encryption processing unit 1406 encrypts content key Kc with session key Ks2d decrypted by decryption processing unit 1412, and produces encrypted data E(Ks2d, Kc) (step S334). Controller 1420 provides encrypted data E(Ks2d, Kc), which is provided from encryption processing unit 1406, to controller 1106 of terminal device 20 via bus BS3, ATA-interface 1438 and terminal 1439 (step S335), and controller 1106 accepts encrypted data E(Ks2d, Kc) (step S336). Controller 1106 provides encrypted data E(Ks2d, Kc) to decryption processing unit 1510 via bus BS2 (step S337), and decryption processing unit 1510 accepts encrypted data E(Ks2d, Kc) (step S338).

Thereby, decryption processing unit 1510 decrypts encrypted data E(Ks2d, Kc) with session key Ks2d provided from session key generating unit 1508, and accepts content key Kc (step S339). Thereby, the usage permission ends normally (step S340).

For reproducing the content, controller 1106 requests encrypted content data E(Kc, Dc) to hard disk unit 40 after the end of the usage permission of license LIC to reproducing circuit 1550. Thereby, controller 1420 of hard disk unit 40 obtains encrypted content data E(Kc, Dc) from normal data storage region 2110, and provides it to terminal device 20 via bus BS3, ATA-interface 1438 and terminal 1439.

Controller 1106 of terminal device 20 obtains encrypted content data E(Kc, Dc), and provides it to reproducing circuit 1550 via bus BS2.

Decryption processing unit 1516 of reproducing circuit 1550 decrypts encrypted content data E(Kc, Dc) with content key Kc provided from decryption processing unit 1510 to obtain content data Dc.

Decrypted content data Dc is provided to content decoder 1518. Content decoder 1518 reproduces content data, and D/A converter 1519 converts the digital signals into analog signals, and provides them to terminal 1530. Music data is provided from terminal 1530 to an external output device such as a television monitor. The user can enjoy the content reproduced by the output device.

The reading of encrypted content data E(Kc, Dc) from hard disk unit 40 is performed by the processing of reading the normal data in step S70 illustrated in FIG. 11, and therefore, detailed description thereof is not repeated.

The above can be easily achieved by replacing content key Kc in the license with the data, of which security is to be ensured.

[Normal Data Write Processing]

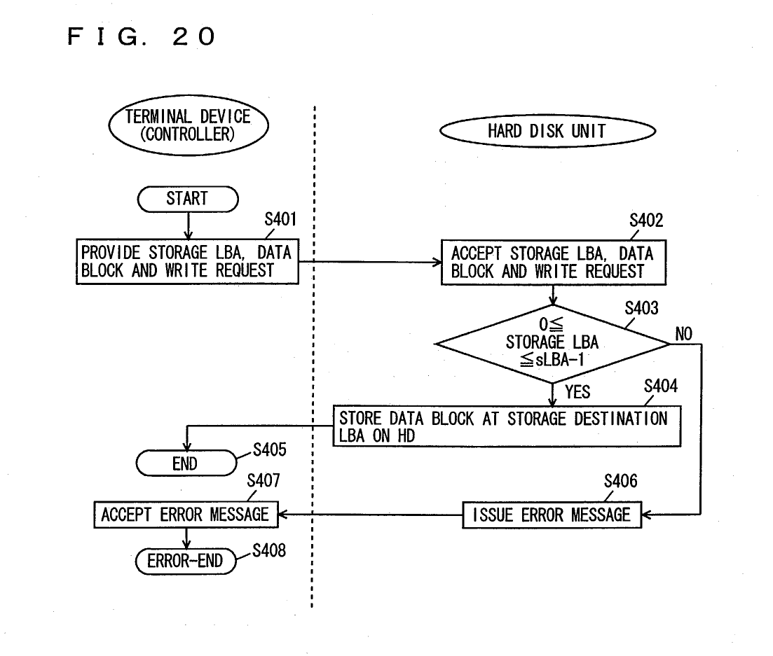

Referring to FIG. 20, a detail operation for the normal data write processing (step S60) illustrated in FIG. 11 will now be described. When the operation starts, controller 1106 of terminal device 20 provides storage LBA for storing the normal data, a data block of 512 bytes to be recorded in the storage block specified by storage LBA, and a write request to hard disk unit 40 via bus BS2 and hard disk interface 1200 (step S401). Controller 1420 of hard disk unit 40 accepts storage LBA, the data block and the write request via terminal 1439, ATA-interface 1438 and bus BS3 (step S402), and determines whether accepted storage LBA falls within the range of logical addresses from 0 to sLBA assigned to normal data storage region 2110 or not (step S403). When storage LBA exceeds the range of logical addresses from 0 to sLBA, controller 1420 provides an error message via bus BS3, ATA-interface 1438 and terminal 1439 (step S406), and terminal device 20 accepts the error message (step S407) so that a series of processing ends due to the error (step S408).

When it is determined in step S403 that storage LBA falls within the range of logical addresses from 0 to sLBA, controller 1420 instructs seek control unit 1425 to move heads 1435-1437 for recording the license at accepted storage LBA. Also, controller 1420 instructs storage/read processing unit 1424 to record accepted data block in the storage block of normal data storage region 2110 corresponding to storage LBA on hard disks 1430 and 1431. Storage/read processing unit 1424 records the accepted data block in the region designated by storage LBA via heads 1435-1437 fixed to the ends of respective arms 1433A-1433C (step S404). Thereafter, the normal data write processing normally ends (step S405).

[Normal Data Read Processing]

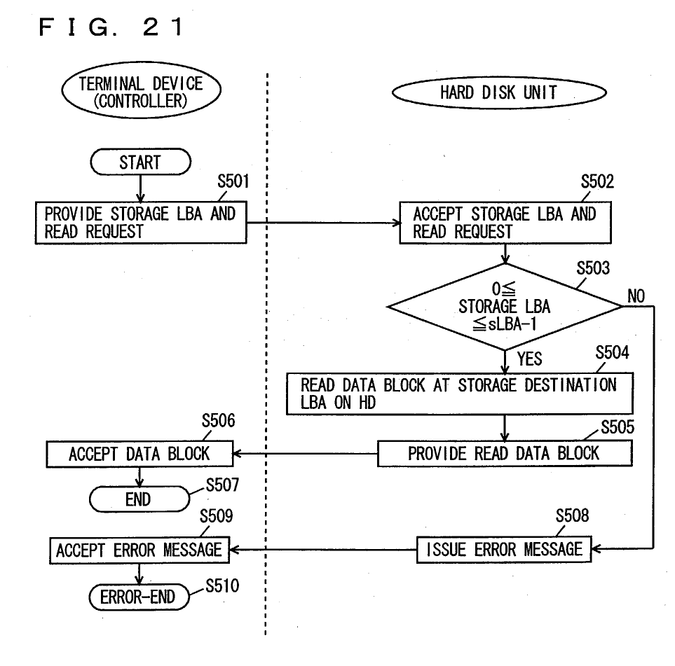

Referring to FIG. 21, description will now be given on detail operation for the normal data read processing (step S70) illustrated in FIG. 11. When the operation starts, controller 1106 of terminal device 20 issues storage LBA for reading the normal data as well as a read request to hard disk unit 40 via bus BS2 and hard disk interface 1200 (step S501). Thereby, controller 1420 of hard disk unit 40 accepts storage LBA and the read request via terminal 1439, ATA-interface 1438 and bus BS3 (step S502), and determines whether accepted storage LBA falls within the range of logical addresses from 0 to sLBA assigned to normal data storage region 2110 or not (step S503). When storage LBA exceeds the range of logical addresses from 0 to sLBA, controller 1420 provides an error message via bus BS3, ATA-interface 1438 and terminal 1439 (step S508), and terminal device 20 accepts the error message (step S509) so that a series of operations end due to the error (step S510).

When it is determined in step S503 that storage LBA falls within the range of logical addresses from 0 to sLBA, controller 1420 instructs seek control unit 1425 to move heads 1435-1437 for reading the license recorded at the accepted storage LBA, and also instructs storage/read processing unit 1424 to read the data block recorded in the storage block of normal data storage region 2110 corresponding to storage LBA on hard disks 1430 and 1431. Storage/read processing unit 1424 reads the data block from the storage block designated by storage LBA via heads 1435-1437 fixed to the ends of respective arms 1433A-1433C (step S504). Then, storage/read processing unit 1424 provides the read data block onto bus BS3, and controller 1420 provides the read data block to terminal device 20 via ATA-interface 1438 and terminal 1439 (step S505). Terminal device 20 accepts the data block (step S506), and the normal data read processing ends normally (step S507).

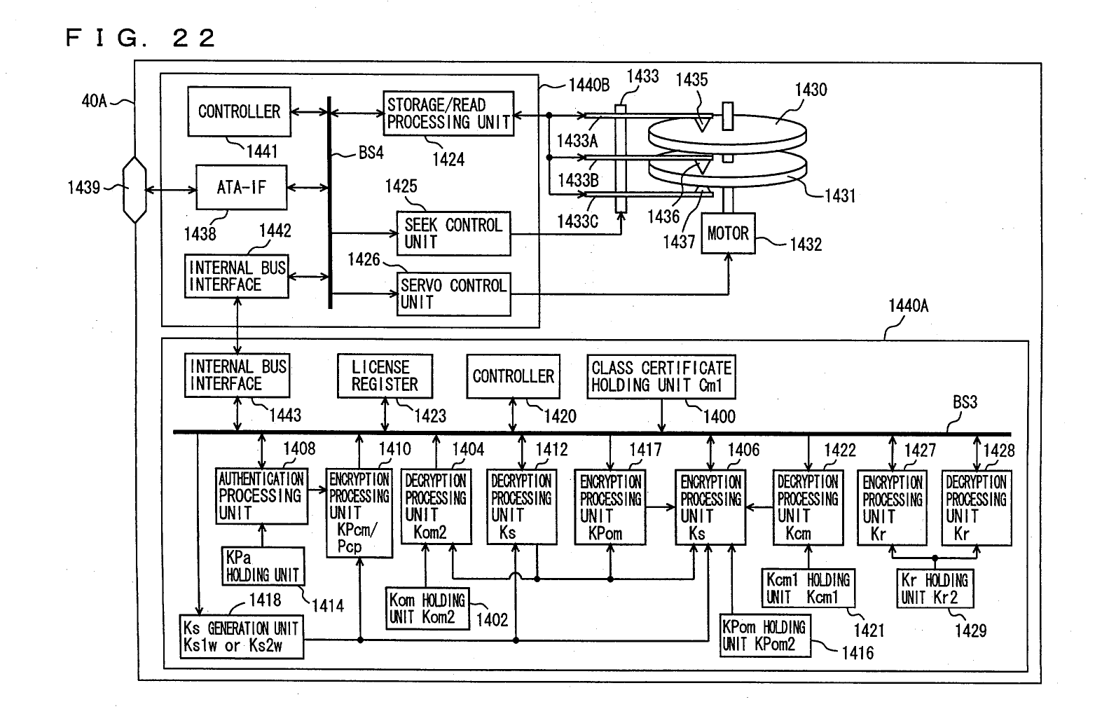

A hard disk unit 40A shown in FIG. 22 may be used as the hard disk unit according to the invention. Referring to FIG. 22, hard disk unit 40A includes control units 1440A and 1440B, hard disks 1430 and 1431, support 1433, arms 1433A-1433C, heads 1435-1437, and terminal 1439.

Support 1433, arms 1433A-1433C, heads 1435-1437, and terminal 1439 are the same as those already described.

Control unit 1440A includes bus BS3, certificate holding unit 1400, Kom2 holding unit 1402, decryption processing units 1402, 1412, 1422 and 1428, encryption processing units 1406, 1410, 1417 and 1427, authentication processing unit 1408, KPa holding unit 1414, KPom holding unit 1416, session key generating unit 1418, controller 1420, Kcm holding unit 1421, license register 1423, Kr holding unit 1429 and an internal bus interface 1443.

Bus BS3, certificate holding unit 1400, Kom2 holding unit 1402, decryption processing units 1402, 1412, 1422 and 1428, encryption processing units 1406, 1410, 1417 and 1427, authentication processing unit 1408, KPa holding unit 1414, KPom holding unit 1416, session key generating unit 1418, controller 1420, Kcm holding unit 1421, license register 1423 and Kr holding unit 1429 are the same as those already described. Internal bus interface 1443 is provided for transmitting data between controller 1420 and control unit 1440B.

Control unit 1440B includes a bus BS4, storage/read processing unit 1424, seek control unit 1425, servo control unit 1426, ATA-interface 1438, a controller 1441 and an internal bus interface 1442.

Storage/read processing unit 1424, seek control unit 1425, servo control unit 1426 and ATA-interface 1438 are the same as those already described. Controller 1441 transmits data to and from various units in control unit 1440B via bus BS4, and also transmits data to and from terminal device 20 via ATA-interface 1438 and terminal 1439. Internal bus interface 1442 is provided for transmitting data between controller 1441 and control unit 1440A.

Control unit 1440A is provided primarily for controlling the recording and/or reproducing of the classified data on hard disks 1430 and 1431. Control unit 1440B is provided primarily for controlling the recording and/or reproducing of non-classified data on hard disks 1430 and 1431.

As described above, the structure of the hard disk unit is divided into the control system for recording and/or reproducing the classified data and the control system for recording and/or reproducing the non-classified data. This allows fast recording and reproducing for the following reasons. Since hard disks 1430 and 1431 are record mediums allowing multi-access, control unit 1440B can record and/or reproduce the non-classified data on hard disks 1430 and 1431 in parallel with the operation, in which control unit 1440A records or reproduces the license for decrypting the encrypted content data on and/or from hard disks 1430 and 1431.

By using hard disk unit 40A, therefore, parallel processing can be performed to execute multiple kinds of processing selected from the initializing processing, protection data write processing, shift/copy processing of protection data, usage permission processing of protection data, normal data write processing and normal data read processing. Each processing is performed in accordance with the flow charts of FIGS. 11-21.

In the above description, license LIC is stored for ensuring the security of protection data storage region 2120 in such a manner that encrypted license E(Krz, LIC) encrypted with unique record key Krz is recorded. However, it is not essential to encrypt license LIC with unique record key Krz when the security of license LIC recorded on hard disks 1430 and 1431 can be ensured in another manner, and thus when leakage of the license from hard disks 1430 and 1431 can be prevented.

For example, hard disk units 40 and 40A may have structures, which can ensure the security without employing the encryption. Also, storage/read processing unit 1424 may employ a unique modulation manner for recording license LIC on hard disks 1430 and 1431, and therefore the security can be ensured without employing the encryption. In these cases, foregoing encryption of license LIC is not necessary.

In these cases not employing the encryption, encryption processing unit 1427, decryption processing unit 1428 and Kr holding unit 1429, which are the function blocks relating to unique record key Krz, are removed from hard disk unit 40 shown in FIG. 8 and hard disk unit 40A shown in FIG. 22. In the classified data write processing, classified data shift/copy processing and the classified data usage permission processing, processing relating to unique record key Krz can likewise be eliminated. Detail description will not be given on these changes.

According to the flow charts shown in FIGS. 13 to 19, description has been given on procedures of input/output (“write” and “shift/copy”) of the license to be recorded in protection data region 2120, or of the output (“usage permission”) of a part of it, and particularly, description has been given on procedures between the data storing device (hard disk units 40 and 41) and the license destination (i.e., license supply device 30 viewed from hard disk unit 40, and hard disk unit 40 viewed from hard disk unit 41), or the license destination (hard disk unit 41 and reproducing circuit 1550 viewed from hard disk unit 40), However, the procedures are not restricted to the foregoing. It is merely required that the data storing device includes an cipher communication unit, which exchanges the keys with the license destination or the destination, and finally outputs the license or a part of the license in the encrypted state. It is desirable to employ the destination determining unit for determining the safety relating to the destination when outputting the license or a part of the license.

The writing and reading of one data block into and from the storage block specified by one LBA have been described as the normal data write processing and the normal data read processing. However, as can be apparent from the fact that each of hard disk units 40 and 41 is provided with ATA-interfaces 1438, it is possible to instruct the writing and reading of a plurality of data blocks into and from a plurality of storage blocks specified by continuous logical addresses LBA. This is achieved by designating the leading LBA and the number of storage blocks for continuous writing or reading. The number of data blocks, on which data is input or output via ATA-interface 1438, match with the number of designated storage blocks.

The description has been given on the example relating to the license for decrypting the encrypted content data. However, the invention is not restricted to the case of handling the license used for decrypting the encrypted content data, and may be applied to other cases of handling data (e.g., personal information or information of a credit card), which need security and must avoid such situation that the same two data are simultaneously present. In the other cases described above, the foregoing processing can be performed.

The other cases described above can be easily achieved by replacing the content key Kc in the license with the data requiring the security.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data storing device inputting/outputting classified data and non-classified data, and storing said classified data and said non-classified data, comprising:
an interface performing external input and output of data;
data storing means storing data;
cipher communication means forming an cipher path to a supplier or a receiver of said classified data in input/output of said classified data via said interface, and performing the input/output of said classified data via said cipher path; and
control means, wherein
said data storage means includes a user region for storing said classified data and said non-classified data;
said user region is divided into:
a first storage region storing said classified data, and a second storage region defined by subtracting said first storage region from said user region, and storing said non-classified data; and
said control means writes or reads the data input or output via said interface and said cipher communication means, as said classified data, into or from said first storage region, and writes or reads the data input or output via only said interface, as said non-classified data, into or from said second storage region.

2. The data storing device according to claim 1, wherein
said user region can be designated by continuous addresses, and
said data storing device further comprises function information means providing, to said interface, function information required for using said data storing device and including at least information for specifying an address range designating said first storage region and/or said second storage region, and information required for performing cipher communication via said cipher communication means.

3. The data storing device according to claim 2, wherein
division into said first and second storage regions is changed by inputting via said interface a changed value specifying a range of an address specifying said first and/or second storage region(s).

4. The data storing device according to claim 2, further comprising:
encryption processing means encrypting said classified data with a private key administered within said data storing device; and
decryption processing means decrypting said encrypted classified data with said private key, wherein
in writing said classified data,
said encryption processing means encrypts said classified data provided via said cipher communication means with said private key, and
said control means receives via said interface an address in said first storage region for writing said classified data provided via said cipher communication means, and stores the encrypted classified data encrypted by said encryption processing means at the region designated by said received address in said first storage region;
in reading said encrypted classified data,
said control means receives the address in said first storage region for reading out said classified data via said interface, reads said encrypted classified data from the region designated by said received address in said first storage region and provides said encrypted classified data to said decryption processing means; and
said decryption processing means decrypts said encrypted classified data provided from said control means with said private key.

5. The data storing device according to claim 4, wherein
said cipher communication means is formed of an independent semiconductor element.

6. The data storing device according to claim 3, wherein
said changed value is a boundary address designating a boundary between said first storage region and said second storage region.

7. The data storing device according to claim 1, wherein
said cipher communication means includes:
authenticating means receiving a certificate provided from other device, and performing authentication processing of authenticating the received certificate, and
communication control means;
in reading said classified data,
said communication control means provides the certificate received via said interface to said authenticating means, forms an cipher path to an output destination of said certificate when said authenticating means authenticates said certificate, and externally outputs an error message via said interface when said certificate is not authenticated.

8. The data storing device according to claim 7, wherein
said data storing means further includes a non-user region for recording a certificate revocation list including information specifying a certificate inhibiting output of said classified data;
said communication control means reads said certificate revocation list from said non-user region, and further determines whether the certificate provided from other device is specified in said certificate revocation list or not;
in reading said classified data,
when said authenticating means authenticates said received certificate, said communication control means reads said certificate revocation list from said non-user region, determines whether said received certificate is specified in said certificate revocation list or not, forms the cipher path to the output destination of said certificate in response to determination that said received certificate is not specified in said certificate revocation list, and externally outputs the error message via said interface in response to determination that said received certificate is specified in said certificate revocation list.

9. The data storing device according to claim 8, wherein
in writing said classified data,
when said communication control means receives a new certificate revocation list together with said classified data, said communication control means overwrites the certificate revocation list stored in said non-user region with said received certificate revocation list.

10. A data storing device inputting/outputting classified data and non-classified data, and storing said classified data and said non-classified data, comprising:
an interface performing external input/output of the data;
a disk-like magnetic record medium storing the data;
write/read processing means performing writing and reading of the data into and from said disk-like magnetic record medium;
cipher communication means forming an cipher path to a supplier or a receiver of said classified data in input/output of said classified data via said interface, and performing the input/output of said classified data via the formed cipher path; and
control means, wherein
said disk-like magnetic record medium includes a user region keeping a constant storage capacity for storing said classified data and said non-classified data,
said user region is divided into a first storage region storing said classified data, and a second storage region defined by subtracting said first storage region from said user region for storing said non-classified data, and
said control means controls said write/read processing means to write or read, as said classified data, the data provided via said interface and said cipher communication means, and controls said write/read processing means to write or read, as said non-classified data, the data input or output via only said interface into or from said second storage region.

11. The data storing device according to claim 10, further comprising:
encryption processing means encrypting said classified data with a private key administered within said data storing device; and
decryption processing means decrypting said encrypted classified data with said private key, wherein
in writing said classified data,
said encryption processing means encrypts said classified data provided via said cipher communication means with said private key, and
said control means controls said write/read processing means to receive via said interface an address in said first storage region for writing said classified data provided via said cipher communication means, and to store the encrypted classified data encrypted by said encryption processing means at the region designated by said received address in said first storage region;
in reading said encrypted classified data,
said control means controls said write/read processing means to receive the address in said first storage region for reading out said classified data via said interface, and to read said encrypted classified data from the region designated by said received address in said first storage region, and provides said encrypted classified data to said decryption processing means; and
said decryption processing means decrypts said encrypted classified data provided from said control means with said private key.

12. The data storing device according to claim 11, wherein
said cipher communication means is formed of an independent semiconductor element.

13. The data storing device according to claim 10, wherein
said user region can be designated by continuous addresses, and
division into said first and second storage regions is changed by inputting via said interface a changed value specifying a range of an address specifying said first and/or second storage region(s).
